(19) United States
(12) Patent Application Publication
(10) Pub. No.: US 2007/0138208 A1
(43) Pub. Date: Jun. 21, 2007

(54) Dispenser

(75) Inventors: Matthew T. Scholz, Woodbury, MN (US); Claude E. Cybulski, Lake Elmo, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/303,650

(22) Filed: Dec. 16, 2005

(51) Int. Cl. B67D 5/06

(52) U.S. Cl. 222/179; 222/181.3; 222/372

(57) ABSTRACT

Dispensers comprising dispenser valves are described. In one aspect, the dispenser comprises: a connection for connecting the dispenser to a container for holding dispensable product therein; a dispenser valve comprising a valve outlet having a closure element configured to assume an opened condition when the pressure differential across the dispenser valve reaches a cracking pressure and a closed condition when the pressure differential across the dispenser valve is less than the cracking pressure, the dispenser valve configured to permit flow therethrough in only one direction when the closure element is in the opened condition; and a pump mechanism configured to pump dispensable product from the connection to the dispenser valve and to generate the cracking pressure needed to configure the closure element in the opened condition. In embodiments, the dispenser valve can be provided as a duckbill valve, a reed valve or the like.

The present invention relates to dispensers and to systems comprising the dispensers.

### BACKGROUND

Exposure of the hands to potentially infectious materials is of concern in the food industry as well as in health care centers. To address the problem of the potential spread of bacteria and other microorganisms, the art has developed a variety of dispensers and disinfecting or sanitizing products that may be dispensed from such dispensers.

Regardless of the construction of the dispenser, a recurring problem in the art has been the tendency for the outlet of the dispenser valve to become clogged by the dried residue of the sanitizer, disinfectant, soap composition or other product that has been dispensed therethrough. Moreover, dried residue that is left at or near the opening of a dispenser valve may attract potential contaminants between uses of the dispenser. Although attempts have been made to remedy the problem of clogging, the proposed remedies have often involved the use of intricate and sometimes complex mechanical modifications to the dispenser to prevent residue from collecting and drying around the dispenser orifice.

An additional problem with some dispensers can be the ability of the dispenser to easily dispense the first dose of dispensable product. Some pumps require many actuations to prime an empty pump for the very first time.

Improvements are needed in dispensers and dispenser valves, including without limitation dispenser valves intended to be used in the dispensing of sanitizers, soaps and/or disinfecting compositions. Improvements in such valves are desired to minimize or even avoid the aforementioned problem of clogging caused by the presence of dried residue at or near the valve outlet.

### SUMMARY

The present invention provides dispensers comprising dispenser valves. In one aspect, the invention provides a dispenser comprising:
a connection for connecting the dispenser to a container for holding dispensable product therein;
a dispenser valve comprising a valve outlet having a closure element configured to assume an opened condition when the pressure differential across the dispenser valve reaches a cracking pressure and a closed condition when the pressure differential across the dispenser valve is less than the cracking pressure, the dispenser valve configured to permit flow therethrough in only one direction when the closure element is in the opened condition; and
a pump mechanism configured to pump dispensable product from the connection to the dispenser valve and to generate the cracking pressure needed to configure the closure element in the opened condition.

In another aspect, the invention provides a dispenser comprising:
a connection for connecting the dispenser to a container for holding dispensable product therein;
a dispenser valve selected from the group consisting of a reed valve and a duckbill valve, the dispenser valve comprising a valve outlet having a closure element configured to assume an opened condition when the pressure differential across the dispenser valve reaches a cracking pressure and a closed condition when the pressure differential across the dispenser valve is less than the cracking pressure; and
a pump mechanism configured to pump dispensable product from the connection to the dispenser valve and to generate the cracking pressure needed to configure the closure element in the opened condition.

In the description of the embodiments of the invention, certain terms will be understood to have the meaning set forth herein.

“Cracking pressure” in reference to the dispenser valve, refers to the differential pressure across the valve at which forward flow reaches the flow threshold (e.g., measured at 0.001 liter/min for water) for the dispensable product being dispensed.

“Preloaded,” as applied to valves, refers to the need to apply an external force to a check valve in order to urge the valve shut. Likewise, “non-preloaded” valves do not require the application of an external force to urge the valve shut. By way of comparison, check valves that employ a ball and spring to urge the valve shut are preloaded. The valves discussed herein (e.g., duckbill valves and reed valves) are normally closed and, after being opened, return to their closed state due to internal strain produced within the structure and do not require the application of an external force.

“Pump” or “pump mechanism” refers to a device that raises, transfers, or compresses fluids by positive or negative pressure or both.

The present invention is further described for the understanding of those skilled in the art in the context of the embodiments set forth in the Detailed Description together with the various Figures and the appended claims.

### BRIEF DESCRIPTION OF THE DRAWINGS

Embodiments of the invention are described with reference to the accompanying drawings wherein like reference numerals refer to like features, and wherein:

FIG. 1 is a perspective view of a dispenser system with a foot actuated pneumatic bladder pump shown in phantom lines;

FIG. 2 is a front, partial view of the dispenser system of FIG. 1 with a valve assembly shown in a sealed position;

FIG. 3 is a perspective view of a container assembly for the dispenser system of FIG. 1 separated from a bracket/actuator assembly, showing the attachment of the container assembly onto the bracket assembly;

FIG. 3A is partial view, of the dispenser valve of FIG. 3, taken along the 3A-3A line thereof;

FIG. 3B is similar to FIG. 3A but shows, in cross section, an alternate embodiment for the attachment of the dispenser valve;

FIG. 4 is a side view of the dispenser shown in FIG. 1, with a valve assembly shown in a dispense position;

FIG. 5 is a cross-sectional view of a container assembly;

FIG. 6 is a side view of the container assembly in the dispenser of FIG. 1 or 4;

FIG. 7 is a perspective view of a portion of the container assembly of FIG. 6;

FIG. 8 is a bottom view of the container assembly of FIG. 6;

FIG. 9 is a rear view of the container assembly of FIG. 6;

FIG. 10 is a front view of a container compatible with the dispenser system of FIG. 1, the container capable of holding product to be dispensed;

FIG. 11 is a side view of the container of FIG. 10;

FIG. 12 is a top view of the cover for a container assembly for the dispenser system of FIG. 1;

FIG. 13 is a cross-section view of the cover taken substantially along section lines 13-13 in FIG. 12;

FIG. 14 is a cross-section view of the cover taken substantially along section lines 14-14 in FIG. 12;

FIG. 15 is a perspective view of a plug which forms a portion of a container assembly;

FIG. 16 is a cross-section view of the plug of FIG. 15 taken along section lines 16-16 in FIG. 15, with an insert removed to illustrate other details of the plug;

FIG. 17 is a perspective view of a spool element for use in a container assembly;

FIG. 18 is a cross-section view of the spool element of FIG. 17 taken along section lines 18-18 in FIG. 17;

FIG. 19 is a side view of a piston for use in a pump in a container assembly;

FIG. 20 is a cross-section view of the piston of FIG. 19 taken along section lines 20-20 in FIG. 19;

FIG. 21 is a perspective view of a retaining element for use in the container assembly;

FIG. 22 is a cross-section view of the retaining element of FIG. 21 taken along section lines 22-22 in FIG. 21;

FIG. 23 is a front view of a bracket/actuator assembly for the dispenser system of FIG. 1;

FIG. 24 is a side view of the bracket/actuator assembly of FIG. 23 with portions broken away to schematically illustrate internal elements of the assembly;

FIGS. 25-27 are cross-sectional views of portions of a container assembly which illustrate the internal mechanism of the container assembly equipped with an associated dispenser valve;

FIGS. 28-29 are cross-sectional views of portions of a container assembly which illustrate the internal mechanism of the container assembly equipped with an alternate embodiment of a dispenser valve;

FIG. 30 is a bottom plan view of the dispenser valve shown in FIGS. 28 and 29; and

FIG. 31 is a perspective of a portion of a hand actuated piston pump dispenser showing an associated container in phantom and having a dispenser valve attached thereto according to the present invention.

### DETAILED DESCRIPTION

The present invention provides a dispenser. The dispenser includes at least one dispenser valve. The dispenser may be constructed in any of a variety of dispenser constructions including manual or electronic dispensers of various configurations. Manual dispensers include those equipped with conventional hand pumps for dispensing topical products (herein, “dispensable products”). In some embodiments, the dispenser may be constructed like that disclosed in U.S. Pat. No. 5,799,841, issued on Sep. 1, 1998, the disclosure of which is incorporated in its entirety herein by reference thereto. In such embodiments, the dispenser is mechanically complex, and may include an actuation mechanism that allows the user to operate the dispenser without the use of his/her hands. Such dispensers might be found, for example, in health care facilities such hospitals and especially in surgical or critical care facilities or in other environments where adherence to strict hand washing protocols may be required to avoid the spreading of bacteria, viruses, or the like.

The invention also provides at least one dispenser valve suitable as a component in a dispenser or dispensing system for dispensing any of a variety of compositions that may include, for example, aqueous or hydroalcoholic cleansing lotions, gels, mousses, disinfecting or sterilizing fluids, sanitizing gels, other antimicrobial liquids and other compositions that may include one or more volatile components such as solvent(s). For example, lower alcohols such as C₁-C₄ monofunctional alcohols, alkanes, silicon compounds such as hexamethyldisiloxane, cyclic silicones as well as other volatile solvents can be used in products dispensed through the valve of the invention. In general, the dispenser valve can be especially useful in dispensing products formulated with volatile solvents such as those including at least one component having a boiling point less than about 150° C. and/or a heat of vaporization of less than about 550 cal/gm. In some embodiments, the dispenser valve is useful in dispensing products including at least one component having a boiling point less than about 100° C. and/or a heat of vaporization of less than about 250 cal/gm. Moreover, the present invention is useful in preventing the clogging of a dispenser that dispenses products comprising the aforementioned volatile solvents as well as products having a solids content greater than about 2% solids by weight, as determined by loss on drying in an oven at 65° C. In the determination of solids content, 3.00 grams of dispensable product are spread on a 65 mm diameter glass petridish to a uniformly thin length and dried in a forced air convention oven for 60 minutes. After cooling, the petridish is weighed again and the percent solids is calculated.

In embodiments of the invention, the dispenser comprises a dispenser valve capable of opening to release dispensable product from the dispenser and then sealing to prevent the further escape of dispensable product from the dispenser channel. In the sealed condition, dispensable product is effectively prevented from escaping from the dispenser outlet. In the sealed condition, dispensable product that remains in the dispensing channel near the valve outlet is also protected from exposure to air to thereby prevent the evaporation of solvent from the dispensable product and avoid the formation of dried residue. In this manner, clogging of the dispenser is avoided.

In some embodiments described herein, the dispenser valve is a non-preloaded valve. In some embodiments, the invention provides a dispenser comprised of the aforementioned dispenser valve. In still other embodiments, the invention provides a dispenser that includes dispensable product as well as the aforementioned dispenser valve.

Embodiments of the invention are described herein in more detail in connection with certain dispenser constructions comprising a dispenser valve. Such dispensers may include the dispenser construction of the aforementioned U.S. Pat. No. 5,799,841. Those skilled in the art will appreciate that the invention is not limited to any particular dispenser construction but is more broadly applicable to any of a variety of dispenser constructions, especially those used to dispense volatile dispensable products and/or those comprising more than 2% solids by weight. In some embodiments, the invention provides a dispenser with a dispenser valve comprising a valve outlet to dispense dispensable product (e.g., disinfecting formulations, sterilizing fluids, sanitizing gels, other antimicrobial liquids) therefrom. The dispenser is provided with a connection for connecting the dispenser to a container assembly comprising a container. A pump mechanism is also provided and is capable of moving dispensable product from a container assembly comprising an associated container and ultimately through the valve outlet. In some embodiments, the invention is provided as a dispensing system, and in some embodiments the invention is a dispensing system that comprises a sanitizing composition.

The art has provided lotion dispensers that typically comprise a valve within the pumping mechanism. However, such dispensers can include dispensing channels of considerable length on the outlet side of the valve, and the outlet at which the fluid is dispensed can remain open (e.g., unsealed) between uses so that undispensed product remains in the channel near the dispenser outlet. In time, volatile solvents and other components of the dispensable product can evaporate and cause the remaining non-volatile components to concentrate in a dried or highly viscous residue. This can result in the formation of a viscous, semi-solid, or solid plug formed around and/or within the tip and channel of the dispenser. When the dispenser is next used, the plug can prevent dispensable product from being dispensed or it can temporarily hamper the proper flow of dispensable product from the dispenser until enough pressure builds behind the plug to force it out of the flow outlet, often resulting in dispensable product spurting out of the tip in a directionally random manner under significant force.

Fluids containing water often include humectants to prevent evaporation of the water (dry out). Humectants such as glycols and the like are often used to bind water and prevent or retard water evaporation and retard or eliminate the aforementioned plugging. For fluids having much more volatile solvents (lower heat of vaporization) it may not be possible to add nonvolatile components to sufficiently reduce volatility and prevent clogging. For example, solvents that include lower alcohols (C1-C4 monofunctional alcohols), alkanes, silicon compounds such as hexamethyldisiloxane, cyclic silicones such as D4, D5 and the like, as well as other volatile solvents often result in clogging when used in dispensable products dispensed from industry standard dispensers.

Typical lotion pumps used with volatile carriers that contain non-volatile components such as emulsifiers, emollients, polymeric thickeners, active ingredients and other components that are solids at temperatures of 20° C. and higher are all prone to clogging. Moreover, the problem is exaggerated as the level of non-volatile components increases and especially as the level of solid and/or viscosifying component(s) increases. For example, clogging is a problem when the total solid non-volatile component(s) exceed 2 percent by weight (as determined by loss on drying in an oven at 60° C.) and is particularly a problem when the total solid non-volatile component(s) exceed 4 percent by weight. The problem is even worse when the non-volatile component(s) exceed 6% by weight. The problem is further exaggerated by the presence of components such as polymeric components that increase the viscosity of the composition. Many polymeric components increase the dispensable product viscosity very rapidly and in some cases almost exponentially as the concentration of polymer is increased. For example, certain polyethoxylated components, polysaccharides and their derivatives, and certain polyacrylates such as polyacrylic acids may cause the dispensable product in the nozzle to increase in viscosity very rapidly due to a rise in concentration as the aqueous or hydroalcoholic carrier evaporates. The problem also is exaggerated by the presence of components such as surfactants, emulsifiers, and emollients that are solids at room temperature. As these materials concentrate they often crystallize or otherwise separate from the continuous phase forming a viscous mass and ultimately a plug. Typical emollients and emulsifiers can be found in U.S. Pat. No. 5,951,993, the entire disclosure of which is incorporated herein by reference thereto. Typical viscosifying polymers may be found in U.S. Pat. Nos. 6,582,711 and 5,167,950 the entire disclosures of which are incorporated herein by reference thereto.

In the various embodiments of the invention, the dispenser comprises a non-preloaded dispenser valve that avoids the aforementioned problems of clogging caused by solvent evaporation and the like. Non-preloaded valves are typically comprised of one or two components and are easy to assemble, and the associated assembly is thus often easier to automate. Moreover, the cracking pressure for a non-preloaded valve is less than that for a preloaded valve which can be important in dispensing topical compositions because a high cracking pressure can result in the dispensable product being dispensed with an excess of force, potentially splattering into the hand and causing a mess. Furthermore, the cracking pressure for a non-preloaded valve is often more reproducible because the valve is less prone to becoming “stuck” in the closed position.

The dispenser valve is capable of reacting to the pressure generated within a dispenser to assume an opened condition at cracking pressures, in some embodiments, less than about 20 mbar. In some embodiments, the dispenser valve can assume an opened condition at a cracking pressure less than about 12 mbar, and in some embodiments the cracking pressure can be less than about 3 mbar. In the absence of sufficient pressure, the dispenser valve will maintain itself in a closed or sealed condition wherein dispensable product is prevented from passing through the dispenser valve and wherein dispensable product within the valve is protected from exposure to the atmosphere outside of the dispenser. Moreover, regardless of the specific embodiment, the dispenser valve of the invention is constructed to operate on a “one-way” basis, allowing dispensable product to be dispensed from the dispenser through the valve but operating to check or prevent flow of air, dispensable product or other fluid in the opposite direction, thus sealing the dispenser and protecting the dispensable product therewithin from exposure to external air. The use of a one-way valve also facilitates the initial priming of the pump mechanism by preventing significant amount of air from leaking back into the pumping chamber during the intake stroke. In this manner, the dispensable composition is drawn into the pumping chamber rapidly. In some embodiments, the first dose is dispensed after less than ten full actuations. In some embodiments, the first dose is dispensed after less than eight full actuations. In other embodiments, the first dose is dispensed after less than four full actuations.

In some embodiments, the dispenser valve is of a one-piece construction such as a duckbill valve, for example. A one-piece construction may be advantageous for assembly of the dispenser, especially where the assembly process is automated. In some embodiments, the dispenser valve is provided in the form of a reed valve. A reed valve can consist of a single component as well, i.e., the reed, if the nozzle is molded to have a seat and to properly receive and secure the reed. Alternatively, the reed valve may consist of two components—a reed and a seat that is fixed to the nozzle. Although a one-piece construction may be advantageous, as mentioned, two piece constructions are also contemplated. Dispensers equipped with a dispenser valve according to the invention, are able to dispense a reproducible amount of dispensable product within a range from about 10% to about 15% (±10%-15%) measured on a weight basis. In some embodiments of the invention, the dispenser may be equipped with multiple (e.g., at least two) valves in series.

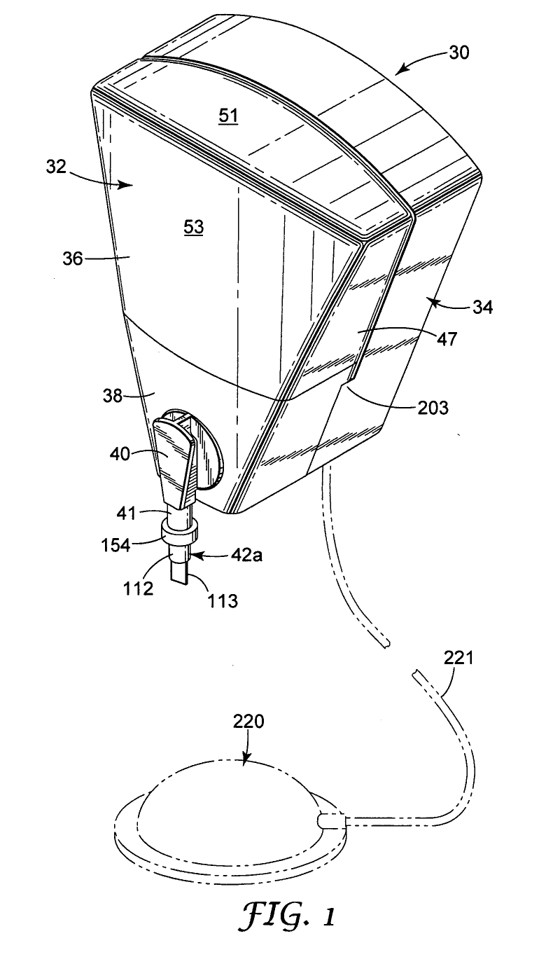

Referring generally to the Figures, embodiments of the invention are illustrated and will now be described. FIGS. 1-3 show a dispenser 30 that includes a container assembly 32 removably attachable to a bracket/actuator assembly 34. The bracket/actuator assembly 34 includes an actuator (generally designated by reference numeral 196) that is movable between a retracted position allowing attachment of the container assembly 32 to the bracket/actuator assembly 34 and an extended position for actuating the dispenser 30 and dispensing a volume of dispensable product. The bracket/actuator assembly 34 also includes a pair of inwardly directed mounting flanges 200 and 202.

The container assembly 32 includes a container (or container) 36 for holding dispensable product to be dispensed such as cleansing, disinfecting or sterilizing liquids, fluids, compositions or solutions, such as antiseptic soaps, hydroalcoholic solutions, disinfecting lotions, cleaning solutions, other antimicrobial liquids, and the like. Such dispensable product may comprise antiseptic moisturizing lotions such as those sold commercially under the trade designation AVAGARD™ by 3M Company of St. Paul, Minn. While the dispenser 30 is suitable for dispensing antimicrobial liquids that include volatile solvents or other volatile ingredients, the dispenser 30 is also capable of dispensing other compositions. In some embodiments of the invention, the container assembly is disposable. In other words, the container assembly 32 is prefilled (e.g., by a commercial manufacturer or supplier) with dispensable product so that the container assembly 32 may be placed directly within the dispenser 30 and used until all of the dispensable product provided with the container assembly is depleted. Thereafter, the empty container assembly 32 is removed from the dispenser 30, disposed of, and replaced with a new container assembly filled with dispensable product.

In some embodiments, the invention provides a system comprising a container assembly, dispensable product contained within the container assembly and a bracket/actuator assembly. In aspects of the these embodiments, the container assembly is prefilled as mentioned above. In other aspects, the system is a disinfecting system comprising the container assembly filled with a disinfecting or sanitizing composition and a bracket/actuator assembly. Various features of the foregoing system, especially the container assembly and the bracket/actuator assembly, are common to the features of the dispenser described herein.

In some embodiments of the invention, the actuator 196 is controllable without the need for the user to touch the dispenser 30 with his/her hand. In such constructions, the user can avoid the potential risk of contamination that can be associated with the manual actuation of the dispenser 30. In the depicted embodiment, a foot actuated pump 220 is provided in the form of a bladder connected by air hose 221 to port 214. The pump 220 is operable to move the actuator 196 from the retracted position to the extended position by delivering pneumatic pressure to the bracket/actuator assembly 34 when the pump 220 is depressed by the operator. A variety of other structures may also be used to operate the bracket/actuator assembly 34 without requiring hand contact. Such devices would include those that engage a user's foot, knee or elbow, for example. Optionally, circuitry that includes an electronic eye may be used to activate the dispenser 30. Additionally, a wide variety of devices may be used to propel the actuator 196 from the retracted to the extended position and vice versa. For example, the actuator 196 may be propelled by a fluid (e.g. pneumatic or hydraulic), a mechanical device, an electromechanical device or an electro/fluidic device. Examples of fluid driven devices include molded bulbs, bladders, bellows and cylinders. Examples of mechanical devices include linkages, cables and foot pedals. Electromechanical devices include motors and solenoids with and without mechanical linkages. An example of an electrofluid device includes a motor that drives a typical lotion type piston pump. An additional example of an electrofluid device includes an electric compressor.

The container assembly 32 includes a valve assembly (described below) with a flow outlet 42 that is sized and shaped to dispense dispensable product therefrom, and a pump that is operatively associated with the actuator 196 to facilitate the dispensing of dispensable product through the flow outlet 42. The flow outlet 42 is provided by insert 41 connected to the distal end of the dispensing channel 110. Insert 41 is attached to the dispenser channel 110 in a snap-fit, threaded fit, twist-on, press-fit or the like, although adhesive bonding, heat bonding, ultra-sonic welding and the like may also be used for securing the insert 41. In some embodiments, the insert 41 may be eliminated by molding this feature directly into the knob 40 (containing the dispenser channel 110) to form a single one-piece dispenser channel that terminates at the flow outlet 42.

A dispenser valve 42a, is provided to receive dispensable product passing through the flow outlet 42. As mentioned, dispenser valve 42a may be provided as a non-preloaded valve, but is self-sealing so that dispensable product remaining within the dispenser channel 110 is sealed from exposure to the external air to thereby retard or prevent evaporation of solvent. In this manner, dispensable product may remain within the dispenser channel 110 without concern for evaporation of solvent or the accumulation of dried residue.

In some embodiments, the dispenser valve 42a is a duckbill valve made from an appropriate elastomeric material that will readily open at a threshold ‘cracking’ pressure when a volume of dispensable product is being dispensed. In embodiments of the invention, the cracking pressure for the dispenser valve 42a is less than about 20 mbar. In some embodiments, the cracking pressure can be less than about 12 mbar, and in some embodiments, the cracking pressure can be about 3 mbar or less. A duckbill valve made from a suitable elastomeric material will typically possess sufficient ‘material memory’ to consistently cause the valve to seal or re-seal when not dispensing. Use of a duckbill check valve as the dispenser valve 42a provides a free flow of dispensable product with the positive differential pressure generated when the dispenser is actuated. With a negative differential pressure across the valve, backflow is checked.

In the opened condition, dispensable product from the dispenser channel 110 is pushed through the outlet 42 into the valve body 112 and through the opened valve outlet 113b. Valve outlet 113b of closure element 113 opens in a direction generally perpendicular to the flow of dispensable product. After a measured amount of dispensable product has passed through the valve 42a, pressure within the pump chamber 90 and the dispenser channel 110 will fall below the minimum pressure required to maintain the valve 42a in the opened condition. The closure element 113 of dispenser valve 42a will then revert to a closed condition.

Duckbill valves like the dispenser valve 42a, are resilient flow regulator members mounted in a fluid flow path. The valve 42a has as its primary operative components a valve outlet 113b comprised of a resilient closure element 113 extending from closure element inlet 113a at the base of the valve body 112 and converging at valve outlet 113b. The closure element 113 is capable of assuming an opened condition in flexes or expands in response to a cracking pressure, opening valve outlet 113 in a direction perpendicular to the flow of dispensable product to define a flow passage and to permit the flow of dispensable fluid from the valve body 112 into the inlet 113a and exiting the dispenser valve 42a through the valve outlet 113b. In the absence of a cracking pressure across the dispenser valve 42a, closure element 113 assumes a closed condition wherein valve outlet 113b is sealed to prevent further flow or leakage of dispensable product. In this arrangement of parts, the closure element 113 is the final structure for dispensable product to clear seen in exiting the dispenser, so that the dispensable product is not able to accumulate on other structures as it exits the valve 42a. Moreover, the closure element 113, in the closed condition, also seals the valve 42a against backflow so that air is prevented from entering the dispenser valve 42a. In this manner, dispensable product remaining within the valve 42a and the dispenser channel 110 is not exposed to significant volumes of air that might facilitate the formation of a blockage if the dispensable product were able to dry significantly.

Materials suitable for a dispenser valve according to the present invention, such as the duckbill valve 42a, include elastomeric materials which may comprise thermoplastic or thermoset elastomers. Thermoset polymers may be included in embodiments that that dispense compositions having emollients and other components that may otherwise plasticize the elastomer and change its physical properties. Elastomer materials include fluorinated elastomers, such as VITON® brand fluoroelastomer (FKM) made by DuPont Dow Elastomers LLC, Wilmington, Del., USA. Other suitable elastomeric materials include ethylene propylene diene monomer (EPDM); silicone rubber including moisture cured, two part and radiation cured silicones; nitrile rubber; chloroprene rubber (neoprene); natural rubber; synthetic rubber and perfluorinated elastomers (FFKM), such as KALREZ® made by DuPont Dow Elastomers LLC, CHEMRAZ® made by Greene, Tweede & Co., Medical & Biotechnology Group, Hatfield, Pa., USA, and SIMRIZ® sold by Freudenberg-NOK, Plymouth, Mich., USA. Suitable synthetic rubbers include, e.g., a polybutadiene rubber (BR); a polyisoprene rubber (IR); a styrene-butadiene rubber (SBR); and other, block copolymers such as block copolymers of styrene and butadiene, and styrene isoprene such as those and others sold under the “Kraton” trade designation by Kraton Polymers may also be suitable. Thermoplastic elastomer such as that available under the trade designation “Santoprene,” (Grade 271-64) available from Advanced Elastomer may also be suitable. “Natural rubbers” suitable for use in the manufacture of a dispenser valve such as duckbill valve 42a include cis-1,4-polyisoprene, which occurs naturally in over 200 species of plants, including dandelions and goldenrod. Specifically, natural rubber (NR) can be obtained from the Hevea brasiliensis tree, the guayule bush Parthenoim argentatum, or the Sapotaceae tree. The natural rubber (NR) can include cis-polyisoprene, trans-polyisoprene, or a combination of cis- and trans-polyisoprene. Additionally, the natural rubber (NR) can include any suitable amount of polyisoprene, e.g., about 93 wt. % to about 95 wt. % of polyisoprene. For many healthcare applications natural rubber is avoided due to the concern over contaminating proteins to which many people can be allergic.

Both thermoplastic and thermoset polyurethanes also are useful. Certain polyolefins can also be employed including thermoplastic and thermoset polyolefins such as ethylene-propylene diene monomer (EPDM) copolymer, an ethylene-propylene rubber (EPR), metallocene polyolefins such as metallocene polyethylene and metallocene polypropylene may also be suitable.

Any of the elastomers may be filled or unfilled and may contain other additives such as extrusion aides, antioxidants, plasticizers, stabilizers to light, heat, and radiation, and the like.

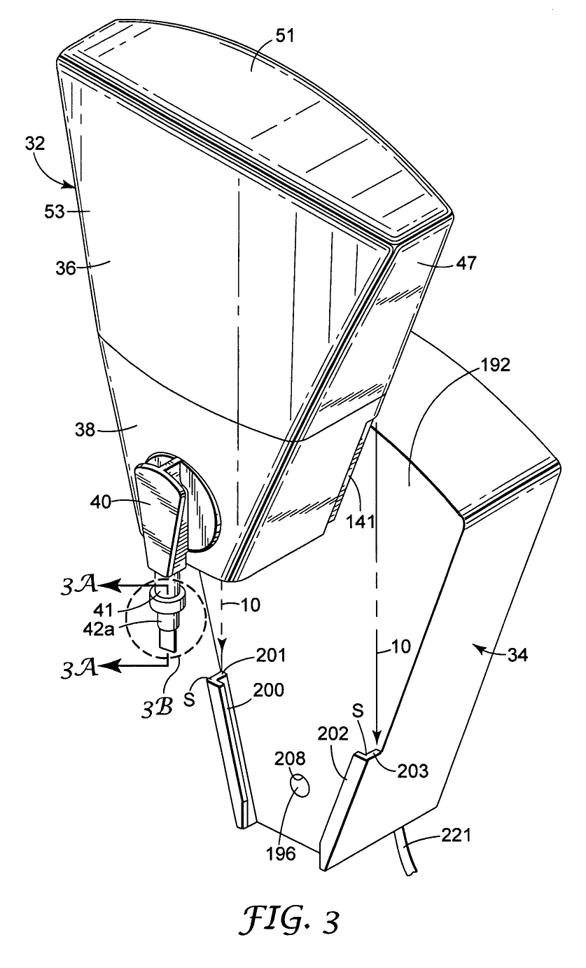

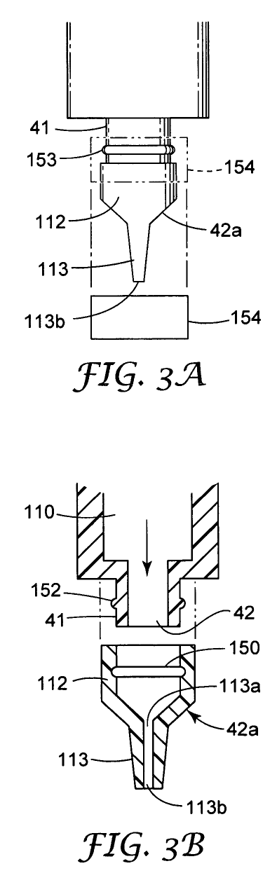

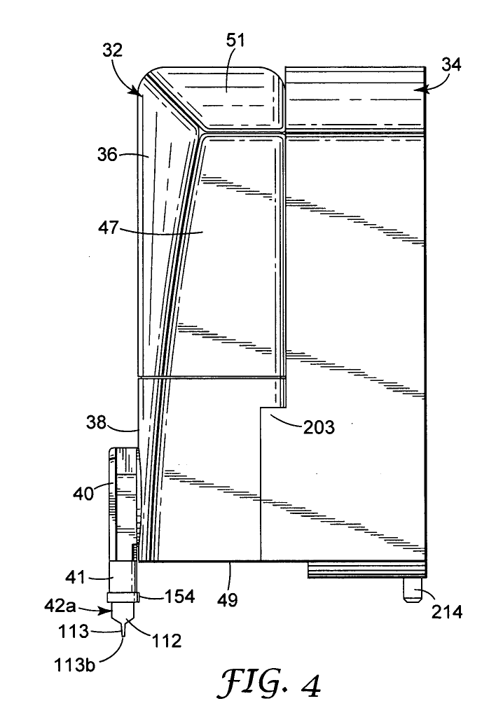

The dispenser valve or duckbill valve 42a may be fixed to the flow outlet 42 by any suitable means including an adhesive bond, a thermal bond, a mechanical fastener or the like. In some embodiments, the duckbill valve can be retained mechanically as is shown in FIG. 3A wherein the valve body 112 of dispenser valve 42a engages the outlet 42 of the dispenser channel 110. A separate retaining collar 154 is provided having an internal detent (not shown) therewithin. The collar 154 is dimensioned and shaped to fit over and retain the valve 42a and to engage ring or rib 153 around the outer surface of the outlet 42 to provide for a fluid-tight ‘snap-fit.’ In some embodiments, as shown in FIG. 3B, the mechanical fastener can comprise, for example, an internal detent 150 within the valve body 112 that engages ring or rib 152 to provide a fluid tight ‘snap-fit’ to retain the dispenser valve 42a over the outlet 42. If desired, the aforementioned snap-fit mechanisms may be further reinforced by application of a suitable adhesive, for example. Other mechanical means for retaining the duckbill valve 42a to the outlet 42 will be apparent to those skilled in the art, and all such embodiments are contemplated within the scope of the present invention.

Commercially available duckbill valves suitable for use in the present invention may be obtained from, for example, Vernay Laboratories, Inc. of Yellow Springs, Ohio.

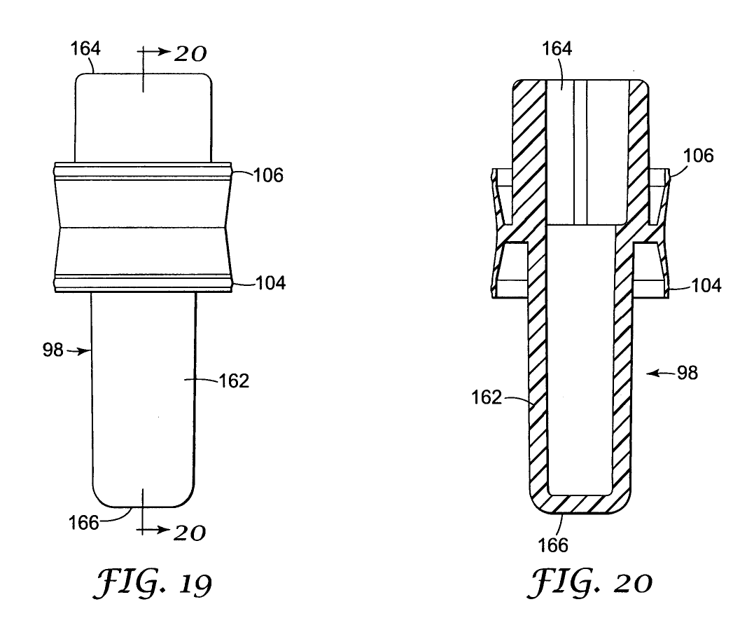

In some embodiments, the pump mechanism for the dispenser 30 is a constant volume pump adapted to deliver reproducible, metered amounts of the dispensable product regardless of the product volume (e.g. fluid level) remaining in the container. The pump mechanism includes piston 98 (e.g., FIG. 19, 20, 26) having a driven surface 164 for receiving the actuator 196. In some embodiments, the dispenser 30 may function with a pump mechanism that varies the volume of dispensable product delivered.

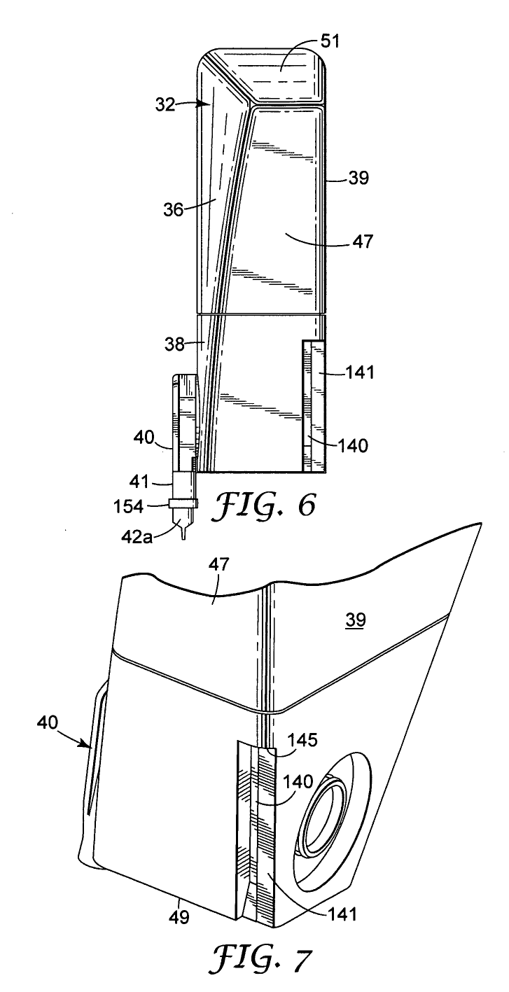

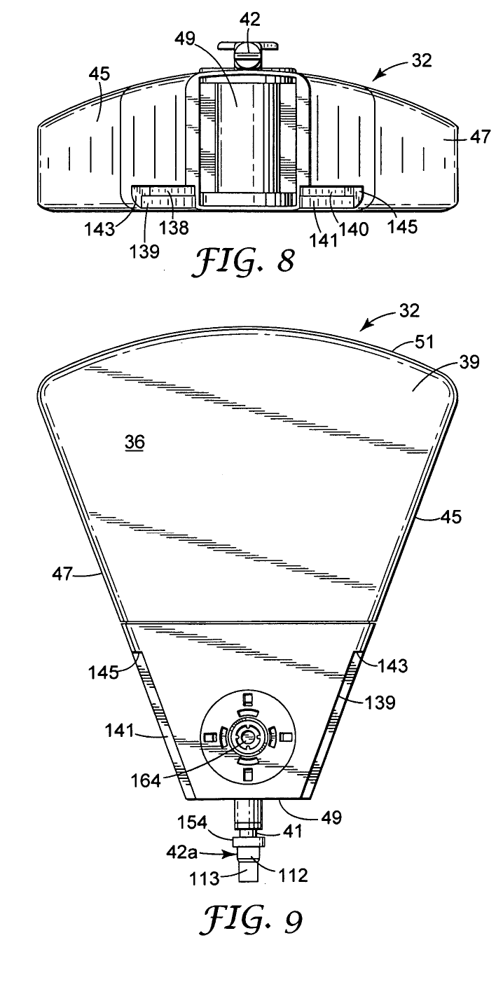

Channels 138 and 140 (FIGS. 6, 8) are provided on container assembly 32 to receive mounting flanges 200 and 202 of the bracket/actuator assembly 34 for attachment of container assembly 32 to bracket/actuator assembly 34 and to properly align the actuator 196 with the internal portions of the dispenser pump, described below, to facilitate the proper operation of the dispenser 30. Channels 138 and 140 taper toward each other in the direction of attachment 10 (FIG. 3) so that the driven surfaces 164 of the piston 98 are automatically guided into a predetermined orientation relative to the actuator 196. In some embodiments, the channels 138 and 140 may be situated to form an acute angle of about forty (40) degrees therebetween, and a vertical height of about 2.1 inches (5.1 cm).

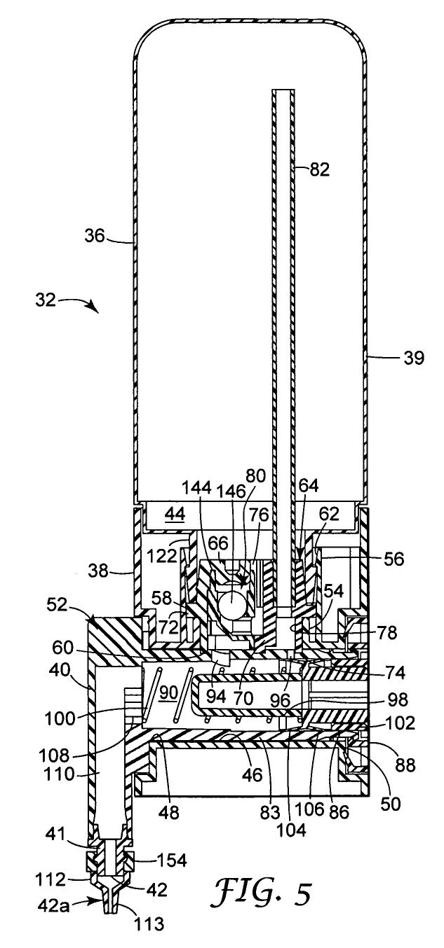

Substantially planar rear wall 39 (e.g., FIGS. 5, 6 and 7) of the container assembly 32 abuts a substantially planar front housing 192 (FIG. 3) of the bracket/actuator assembly 34. If desired, the rear wall 39 may be placed against the housing 192, and the container assembly 32 may be slid downwardly until the flanges 200 and 202 engage the channels 138 and 140.

The container assembly 32 includes a top wall 51, a front wall 53, a pair of tapered side walls 45 and 47, and a bottom wall 49. Each of the side walls 45 and 47 include one of the channels 138 and 140. Referring to FIG. 7, there is shown a bottom, rear portion of the side wall 47. The channels 138, 140 are located in the bottom, rear portion of side wall 47. The top, side and bottom walls of the bracket/actuator assembly 34 form a shape that is substantially identical to the shape of the container assembly 32 to provide a dispenser 30 that is substantially free of discontinuities.

The top wall 51 and front wall 53 have outer surfaces that may be slightly curved while the side walls 45 and 47 may be substantially flat. In some embodiments, the front wall 53 may have a radius of about six inches (15.2 cm) and the top wall 51 may have a radius of about six inches (15.2 cm). In some embodiments, the thickness of the container assembly 32 (the distance between the rear wall 39 and the front wall 53) may be less than about two inches (5.1 cm)

In the depicted embodiment, the flanges 200 and 202 project inwardly from support arms 201 and 203. The container assembly 32 includes recessed ledges 139 and 141 adjacent the channels 138 and 140. The ledges 139 and 141 are recessed from the rest of the side walls 45 and 47 by an amount that is substantially equal to the thickness of the support arms 201 and 203 to provide a substantially flush interface or junction between the container assembly 32 and the bracket/actuator assembly 34.

The channels 138 and 140 each have first ends opening onto the bottom wall 49 and second ends defined by shoulder surfaces 143 and 145 which are adapted to engage stop surfaces S of the mounting flanges 200 and 202 and support arms 201 and 203. Engagement between the stop surfaces S and the shoulder surfaces 143 and 145 terminates the insertion of the container assembly 32 into the bracket/actuator assembly at the point where actuator 196 is properly oriented.

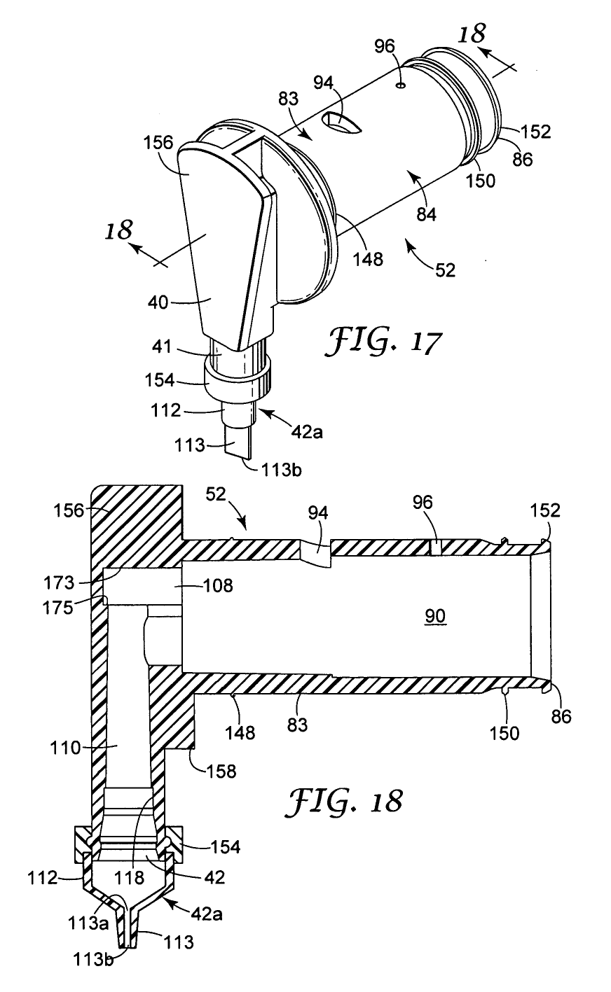

Within the dispensable product flow path between the flow outlet 42 and the container, the container assembly 32 includes a pump mechanism (FIGS. 17, 18) comprised of an assembly with inner surfaces that receive the piston 98 and define a pump chamber 90. Piston 98 is aligned with bracket/actuator 196 in the bracket/actuator assembly 34. The pump chamber valve assembly includes outer surfaces 83 grasping surfaces 40 (e.g. a knob) that are sized and shaped to be manually grasped, dispenser valve 42a, and surfaces extending between the inner and outer surfaces 83 to define a fill hole 94. As described in greater detail below, the knob 40 can be rotated to permit or prohibit flow of dispensable product (e.g. liquid) from the container 36 out through valve 42a.

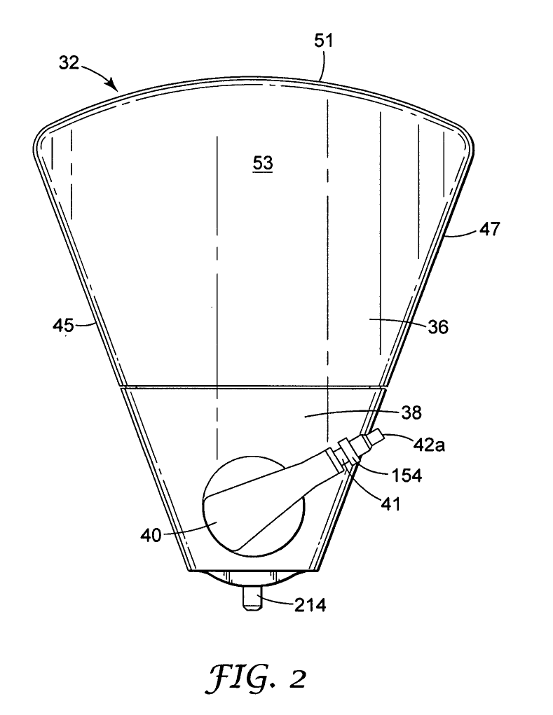

The pump mechanism is mounted within the dispenser 30 and with knob 40 oriented as shown in FIG. 2 so that sealing surfaces 84 seal the fluid container from the pump chamber 90. The pump mechanism can then be positioned in a dispense position by rotating the knob 40 to an orientation as shown in FIGS. 5 and 26-30 so that fill hole 94 is oriented to permit passage of dispensable product from the container 36 to the pump chamber 90. In the sealed position, the pump chamber valve assembly provides a positive seal for the container to enable the shipping, handling or storage of the container assembly 32.

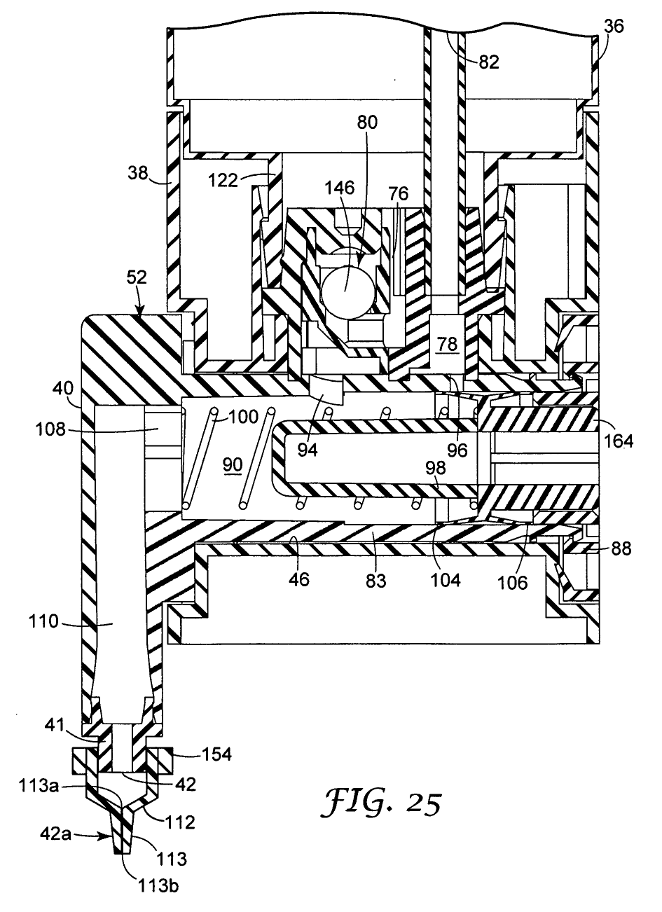

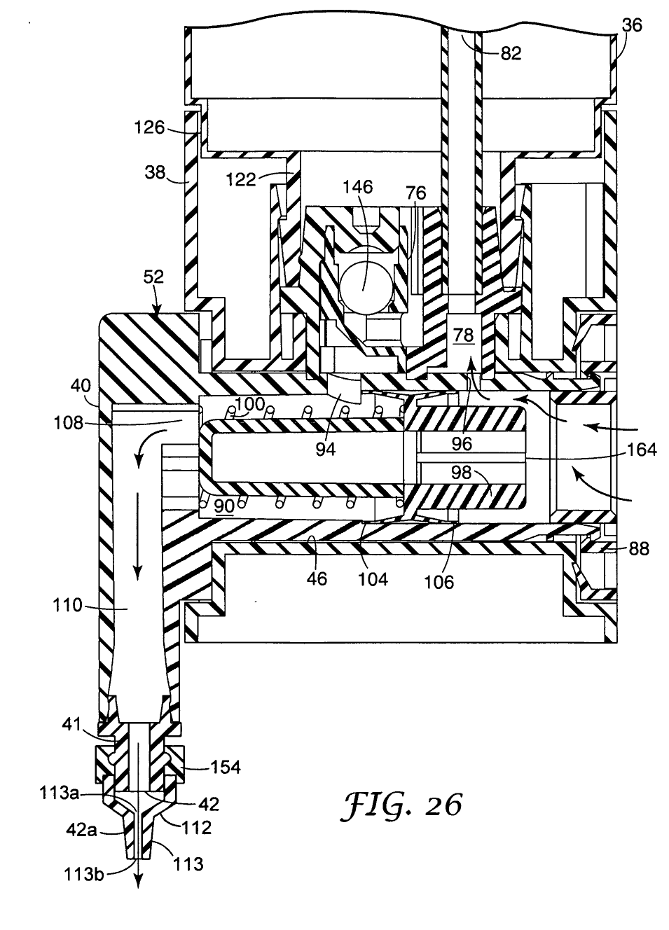

In the embodiment of dispenser 30 shown, in part, in FIGS. 25-27, the pump mechanism is provided as a constant volume pump. Piston 98 (shown in isolation in FIGS. 19 and 20) is mounted within the inner surfaces of the valve assembly for movement between a return position (FIG. 25) and an actuated position (FIG. 26). Under conditions of actual use, the actuator 196 engages surfaces 164 of piston 98 to drive the piston 98 from the return position to the actuated position. Spring 100 is mounted in the pump chamber 90 and is biased against the inner surfaces of the chamber 90 in a manner that also biases piston 98 toward the return position which, in turn, biases the actuator 196 toward a retracted position. position. Certain dispensable compositions may contain components that can be degraded by contact with metals such as spring 100. For these compositions spring 100 may be positioned outside the fluid flow path.

The container assembly 32 includes housing 38 that serves as a connection to the container or container 36. The housing 38 has surfaces defining a passageway 46. The pump mechanism comprises a spool element 52 (FIGS. 17 and 18) adapted to be received within passageway 46 of the housing 38. Spool element 52 is mounted to rotate within the passageway 46 between the sealed and dispense positions. Housing 38 includes a main or upper opening 44 adapted to receive container 36. Passageway 46 includes a first end 48 and a second end 50 on opposite faces which receive the spool element 52. The axis of the passageway 46 in the cover 38, as shown, is perpendicular to the main axis of the disposable container assembly 32 (FIG. 13). A first hollow coaxial boss 54 and a second hollow coaxial boss 56 are oriented to project perpendicularly from the wall of the passageway 46 in the cover 38. First hollow boss 54 includes a first opening 58 at the top and a second opening 60 into passageway 46 (FIG. 5). Second hollow boss 56 includes an opening 62 at the top that is adapted to be connected to the container 36. The cover 38 may be constructed from any suitable material, such as, but not limited to high density polyethylene. In addition to the dispensable product fill hole 94, the spool element 52 preferably includes a vent hole 96 which is a port for the aspiration of replacement air into the container 36.

Container assembly 32 includes a plug 64 having first 76 and second 78 passageways. The first passageway 76 affords passage of dispensable product from the container to the pump chamber 90, and the second passageway 78 affords passage of replacement air into the container 32. The plug 64 may be constructed from an elastomeric material, but may include an insert 144 (see FIG. 5). In some embodiments, the majority of the plug 64 may be constructed from a thermoplastic elastomer such as that available under the trade designation “Santoprene,” (Grade 271-64) available from Advanced Elastomer Systems, and with the insert 144 constructed from a relatively rigid polymer such as high density polyethylene. In the sealed position, the sealing surfaces 84 seal the first and second passageways 76 and 78, and in the dispense position, the fill hole 94 is aligned with the first passageway 76 and the vent hole 96 is aligned with the second passageway 78.

The plug 64 is disposed between the container 36 and the cover 38. Plug 64 includes a conical top portion 66 that is adapted to seal against the inside surface of a neck portion 122 of the container 36, and a bottom portion 70 that fits inside the first hollow boss 54 of the cover 38. The plug 64 also includes an intermediate flange 72 adapted to be compressed between the end of the container neck 122 and the top of the first hollow boss 54 in the cover 38. The bottom portion 70 of the plug 64 is constructed to include a cylindrical surface with a diameter substantially equal to that of the passageway 46 in the cover 38. When the plug 64 is compressed between the container 36 and the cover 38, the bottom surface 74 of the plug 64 projects slightly into the passageway 46 of the cover 38 and seals against spool element 52.

Passageways 76 and 78 communicate between the interior of the container 36 and the spool element 52. First passageway 76 includes a one-way pump inlet valve 80 for preventing the backflow of dispensable product from the pump chamber 90 to the container. The one-way pump inlet valve 80 comprises a ball valve having a ball 146. The ball valve may be constructed from the insert mentioned above. Ball 146 is movable between an open position (see FIG. 27) which affords passage of dispensable product from the container to the pump chamber 90, and a closed position (see FIGS. 25-26) which prevents the flow of dispensable product from the pump chamber 90 to the container. In an embodiment of the invention, container 36 is situated above outlet 42 when the dispenser 30 dispenses the dispensable product. Thus, gravity biases the ball 146 toward the closed position. The dispenser 30 is capable of completely dispensing substantially all of the dispensable product within the container 36, at least partly due to the location of the container 36 above the pump.

Second passageway 78 is adapted to provide a vent 82 (see, e.g., FIGS. 25, 26, 27) for the entrainment of replacement air into the container 36. Piston 98 includes first and second piston seals 104 and 106 to seal the vent hole 96 when the piston 98 is in the return position and to afford passage of ambient air through the vent hole 96, the second passageway 78, vent tube 82 and into the container when the piston 98 is in the actuated position.

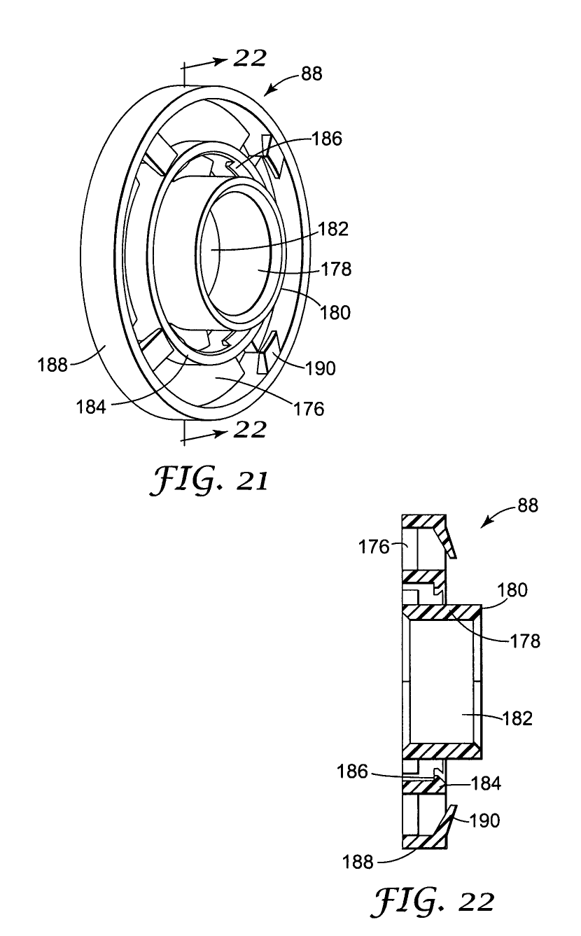

The spool element 52 is adapted to closely fit in the passageway 46 of the cover 38 and includes a hollow cylindrical portion with a first end 86 connected to a retaining element 88 (see FIGS. 21 and 22), a second end that comprises the knob 40, and the pumping chamber 90. The retaining element 88 axially holds the spool element 52 in the passageway 46 of the cover 38 but permits rotation thereof. In the sealed position of the valve assembly, a solid portion (the sealing surfaces 84) of the hollow cylindrical portion of the spool element 52 seals against the elastomeric plug 64 and blocks the first 76 and second 78 passageways that communicate with the liquid in the container 36. Notably, the driven surfaces 164 of the piston 98 preferably do not project out beyond the rear wall 39 of the container assembly which helps reduce the chances of inadvertent or undesirable actuation of the container assembly during shipping, storage or handling prior to use.

The inner cylindrical surface of the spool element 52 seals with piston 98. A boss 102 on the retaining element 88 holds the piston 98 in the spool element 52. In the return position of the piston 98, the vent hole 96 in the spool element 52 is closed between first 104 and second 106 piston seal surfaces. During movement of the piston 98 from the return to the actuated position, dispensable product (e.g. liquid) in the pump chamber 90 flows through a port 108 that connects with an dispenser channel 110 which ends at outlet 42. At least at the end of the movement of the piston 98 to the actuated position, the vent hole 96 is open to the atmosphere.

The dispenser 30 includes a drip resistant valve in the form of dispenser valve 42a affixed to the flow outlet 42 of dispenser channel 110. As shown, the dispenser valve 42a is a duckbill valve made of a resilient elastomeric material capable of sealing the flow outlet 42 to prevent the escape of dispensable product within the dispenser channel 110 until the pump is actuated. Additionally, the dispenser valve 42a prevents outside air from aspirating back into the dispenser channel 110 and pump chamber 90. By sealing the dispenser channel 110, dispenser valve 42a prevents dispensable product, dirt and other contaminants from building up around the outlet 113b and diminishes the chance that dried residue will form at the outlet 113b. Furthermore, dispensable product within the dispenser channel 110 or valve body 112 is sealed from exposure to the atmosphere so that oxygen-sensitive dispensable product is protected against possible oxidation and the evaporation of volatile solvents is avoided.

Referring to FIGS. 25-27, dispenser valve 42a is positioned over outlet 42 at the end of dispenser channel 110 so that dispensable product passing through the outlet 42 is directed through the dispenser valve 42a. Under the pressure delivered by actuation of the piston 98 (e.g., the pump mechanism), dispensable product in the pump chamber 90 and dispenser channel 110 is compressed, resulting in a build-up of pressure until the cracking pressure for the dispenser valve 42a is reached to force the valve outlet 113b into an opened condition, as shown in FIG. 26. In the opened condition, dispensable product from the dispenser channel 110 is pushed into the valve body 112, through the inlet 113a of the closure element 113 and out through the valve outlet 113b. As shown, the valve outlet 113b opens in a direction generally perpendicular to the flow of dispensable product. At the end of the piston stroke for piston 98, a preset or measured amount of dispensable product has passed through the valve 42a, and the pressure within the pump chamber 90 and the dispenser channel 110 will then fall below the cracking pressure of the valve 42a. The dispenser valve 42a will then revert to a closed position in which the elastomeric material of the valve outlet 113b seals to prevent the further egress of dispensable product from the dispenser channel 110. In this manner, dispensable product remaining within the dispenser channel 110 is protected from exposure to drying conditions in the environment outside the dispenser, thereby avoiding the accumulation of dried residue in or around the outlet end 113b. Duckbill valves useful as a dispenser valve in the present invention can be made in any of a variety of dimensions. Various configurations of the valve outlet are available to provide a valve that opens at different cracking pressures suitable for an intended application or to accommodate the internal pressure generated by the dispenser.

When the piston 98 moves from the return to the actuated position, liquid in the pump chamber 90 flows through port 108 into the dispenser channel 110 in knob 40. During movement of the piston 98 from the return to the actuated position shown in FIG. 26, dispensable product in the dispenser follows a flow path through the dispenser channel 110. At approximately the time when dispensable product stops flowing from the pump chamber 90 through the outlet 42, the valve outlet 113b of dispenser valve 42a relaxes from the deflected, dispense position to its relaxed shape in the sealing position.

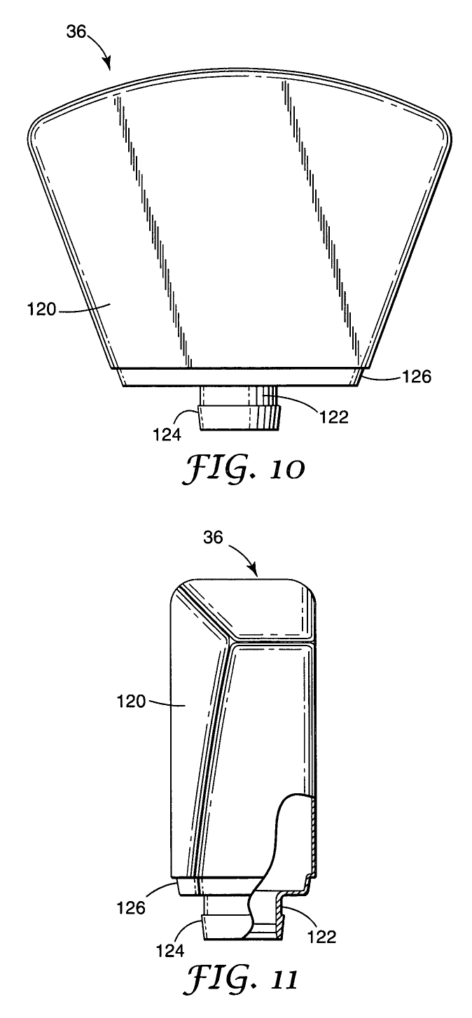

Referring now to FIGS. 10 and 11, the container 36 includes a body portion 120 and neck portion 122 that is adapted to connect to the cover 38. The neck portion 122 of the container is adapted to connect to cover 38 (e.g., shown in FIGS. 6, 12-14) by any convenient means such as a threaded connection, or as in the depicted embodiment, the neck portion 122 of the container 36 includes externally projecting lip 124 that connects to cover 38 by means of a snap-fit. In an embodiment, the container 36 includes a non-circular region 126 that is recessed from the body portion 120. The recessed region 126 is adapted to extend into the cover 38 to prevent rotation of the container 36 after assembly with the cover 38. The container 36 can be fabricated from any material compatible with the dispensable product to be dispensed. In an embodiment, the container 36 is fabricated from a blow molded thermoplastic such as, but not limited to high density polyethylene. Optionally, the entire container 36 or a portion thereof may be constructed from a transparent or semi-transparent material so that the user may visually determine the amount of dispensable product (liquid) that remains in the container.

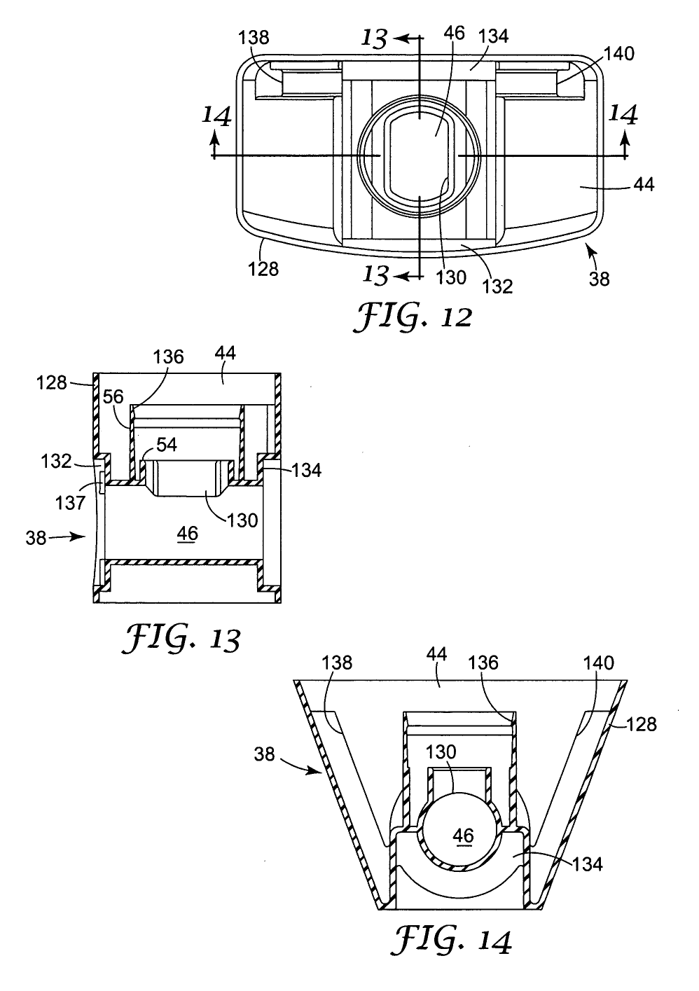

Referring to FIGS. 12 through 14, the cover 38 is seen in isolation. The cover 38 includes an exterior body portion with a main opening 44 adapted to receive container 36 (not shown in these views for clarity). In the embodiment, the main opening 44 is sized and shaped to receive the recessed region 126 on the container 36 (FIG. 10) such that the junction between the container 36 and the cover 38 is essentially flush.

A passageway 46 runs substantially perpendicular to the main axis of the container 36, and there is an orifice 130 in the passageway 46 that is substantially parallel to the main axis of the container 36. The passageway 46 extends completely through the cover 38 and is bounded by a first end 48 on the front face and a second end 50 on the back face. Preferably, the first 48 and second 50 ends are surrounded by first 132 and second 134 countersunk regions. The first countersunk region 132 optionally includes projections 137 that function as a detent or to limit the rotation of the spool element 52. The second countersunk region 134 is adapted to receive retaining element 88.

The cover 38 includes first 54 and second 56 hollow coaxial bosses that project perpendicularly from the passageway 46. The first inner boss 54 surrounds the orifice 130 in the wall of the passageway 46 and is adapted to retain the bottom portion of the plug 64. The top of the first boss 54 is adapted to seat against a flange 72 on the plug 64 and control the distance that the bottom surface of the plug 64 projects into the passageway 46. The second boss 56 connects to the container 36 by any convenient means. In the depicted embodiment, the second boss 56 includes an inwardly projecting lip 136 that connects with the externally projecting lip 124 on the container 36 by means of a snap fit. The second boss 56 can be continuous or can be slotted so as to control the assembly force of the snap-fit joint.

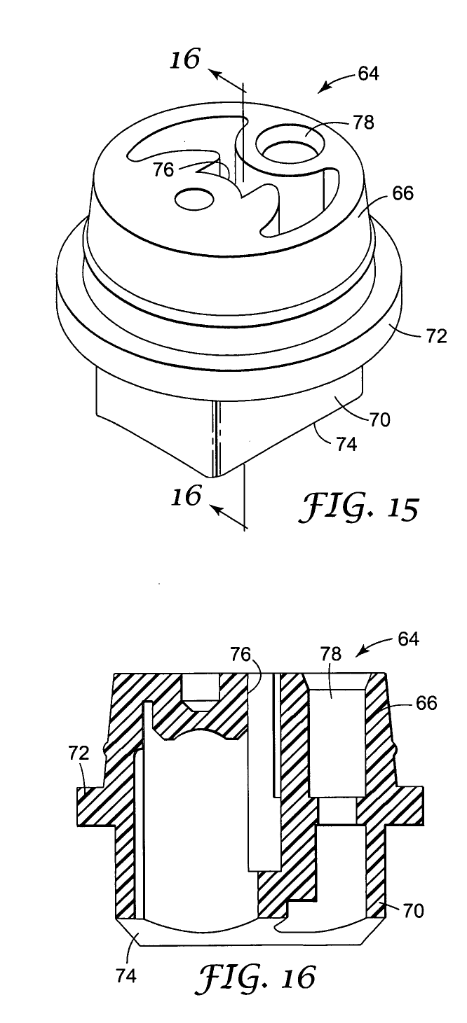

Referring now to FIGS. 15 and 16, the plug 64 is shown in isolation. The plug 64 includes a top conical portion 66 adapted to seal against the inside of the container neck 122, and a bottom portion 70 adapted to fit inside the first boss 54 within cover 38. The bottom surface 74 is adapted to seal against the spool element 52, and an outwardly projecting flange 72 is adapted to seal between the end of the container neck 122 and the top of the first boss 54. Plug 64 includes an outwardly projecting annular rib that is intended to improve the seal between the top conical portion 66 and the inside of the container neck 122. One-way pump inlet valve 80, inserted within first passageway 76, can be of any of several well known types, including valves integrally molded in the elastomeric plug. In some embodiments, as in FIG. 5, the pump inlet valve 80 includes valve seat insert 144 and the valve includes a gravity-biased ball 146 or poppet. In some embodiments, the pump inlet valve 80 could be a spring-biased ball or poppet sealing against an integral valve seat in the plug 64.

The second passageway 78 in the plug 64 retains a first end of a vent tube 82. The second end of the vent tube 82 is above the normal liquid level in the container when the disposable container assembly 32 is mounted in an inverted position on the bracket/actuator 34. Portions of the plug 64 can be fabricated from any elastomeric material that is compatible with the dispensable product to be dispensed. This can be accomplished by molding from, for example, a thermoset elastomer. The portions of the plug shown in FIG. 16 may be injection molded from thermoplastic elastomers with a hardness of 40 to 90 Shore A (e.g. Santoprene elastomer 271-64).

At first end 86, the spool element 52 is adapted to connect to a retaining element 88. Referring now to FIGS. 17 and 18, the second end of the spool element 52 is shaped as a knob 40 that integrally includes dispenser channel 110. The spool 52 includes two externally projecting ribs 148 and 150 that seal with the passageway 46 in the cover 38 by means of an interference fit. The first end 86 of the spool element 52 is adapted to be axially retained in the cover 38 by any convenient means. In the depicted embodiment, the first end 86 of the spool element 52 includes an externally projecting lip 152 that engages a snap fit joint on retaining element 88, but other expedients such as a threaded retainer or a split ring retainer could be used.

The pump chamber 90 is open at first end 86 and is in part defined by the inner surfaces of the knob 40 at the other end. The pump chamber 90 contains the piston 98 and the piston return spring 100. The knob 40 includes a flange 156 adapted for grasping by the hand of a user. The flange 156 of the knob 40 can include projections 158 adapted to limit the rotation of the spool element 52 in the cover 38. In embodiments of the invention, the valve assembly is capable of rotating approximately one-hundred twenty (120) degrees between the sealed and dispense positions.

Referring now to FIGS. 19 and 20, piston 98 is shown in isolation. The piston 98 slidably seals in the pump chamber 90 and includes a rod portion 162. Piston 98 includes multiple piston seals 104 and 106 but, in some embodiments, could include a single sealing surface. The vent hole 96 in the spool element 52 is blocked between the two piston surfaces 104 and 106 in the return position of the piston 98. The two piston surfaces 104 and 106 are supported from the rod portion by any convenient structure. The driven surface 164 transmits the force from an actuator 196 in the bracket/actuator assembly 34, as explained below. The second end 166 of the rod portion 162 retains the piston return spring 100. The piston 98 can be fabricated from any material compatible with the liquid to be dispensed; in the present embodiment, the piston 98 is injection molded from a thermoplastic material, such as, but not limited to high density polyethylene (HDPE).

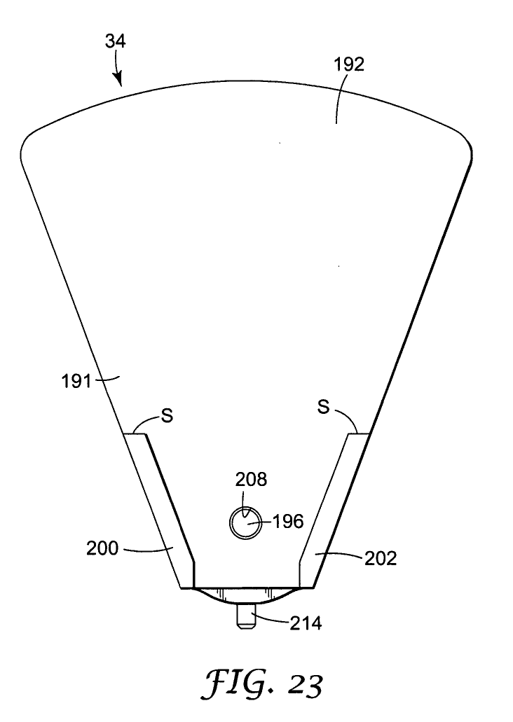

Referring to FIGS. 5, 22 and 23, retaining element 88 connects to spool element 52 to axially hold the spool element 52 in the cover 38 and retain the piston 98 in the spool element 52 in the normal spring-biased (return) position. Expedients for retaining the spool element 52 may be used, such as a threaded retainer or a split ring retainer.

The retaining element 88 includes three concentric bosses projecting from a cylindrical disc portion 176. The first central boss 178 fits inside the spool element 52. The top surface 180 of the first boss 178 retains the piston 98 in the return position. An axial bore 182 in the first boss 178 functions as a bushing for the piston 98 and the reciprocating actuator 196 of the bracket/actuator assembly 34. The second middle boss 184 includes projections 186 that connect to the first end 86 of the spool element 52 by means of a snap fit. The third outer boss 188 includes multiple, inwardly projecting, cantilevered beams 190 that axially bias the spool element 52 against the cover 38. In the present embodiment, the retaining element 88 is injection molded from a thermoplastic material, such as high density polyethylene.

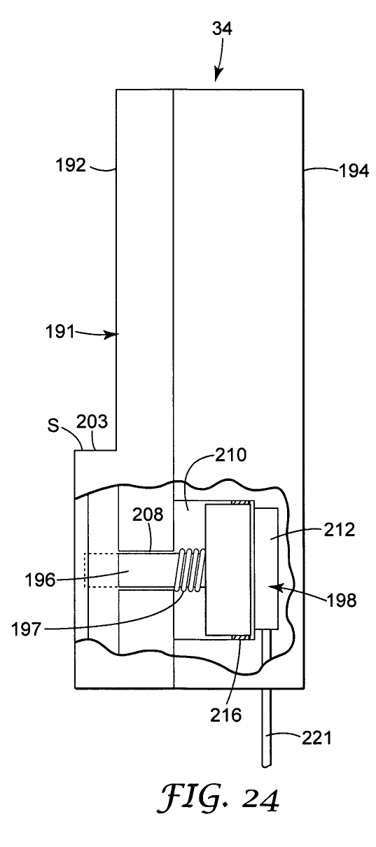

Referring to FIGS. 24 and 25, the bracket/actuator assembly 34 includes a housing 191 including a front housing 192 and a rear housing 194. Mounted within the two housings are the actuator 196 and a means 198 to drive the actuator 196. The front and rear housings 192 and 194 can be fabricated in any convenient shape, although it is desirable to provide an exterior surface with simple planar projections as depicted so as to make the bracket/actuator assembly 34 easy to clean. Preferably, the bracket/actuator assembly 34 is formed from a plastic material in a shape visually similar to the disposable container assembly 32.

The front housing 192 includes a passageway 208 that serves as a bushing for the actuator 196. The means 198 for moving the actuator 196 conveniently includes a cavity 210 in the rear housing 194 in which the actuator can slide forwards and back. An air chamber 212 disposed behind the cavity 210 is in fluid communication with the hose 221 which allows the air chamber to be pressurized. When the air chamber is pressurized, the actuator 196 is moved forward and against the driven surface 164 of the piston 98. The piston return spring 100 in the container assembly 32 helps return the actuator when the air chamber 212 is depressurized. Wall bracket spring 197 biases the actuator 196 in the home position. An actuator seal 216 is provided to prevent leakage of air from the air cavity past the actuator 196. The seal 216 can include any well known devices such as o-rings, v-rings, u-seals, diaphragms, and rolling diaphragms.

While the depicted embodiment shows the actuator 196 being moved pneumatically, the actuator can be reciprocated by any of several well known means including mechanically, for example a mechanical linkage to a user operated lever; electromechanically, for example a solenoid or a motor and a lead screw; or hydraulically, for example a fluid actuator.

The various parts of the container assembly 32 may be injection molded from a suitable material, i.e., thermoplastic material. The spool element 52 can be fabricated from any material compatible with the liquid to be dispensed. In an embodiment, the spool element 52 is injection molded from a thermoplastic material, such as, but not limited to high density polyethylene.

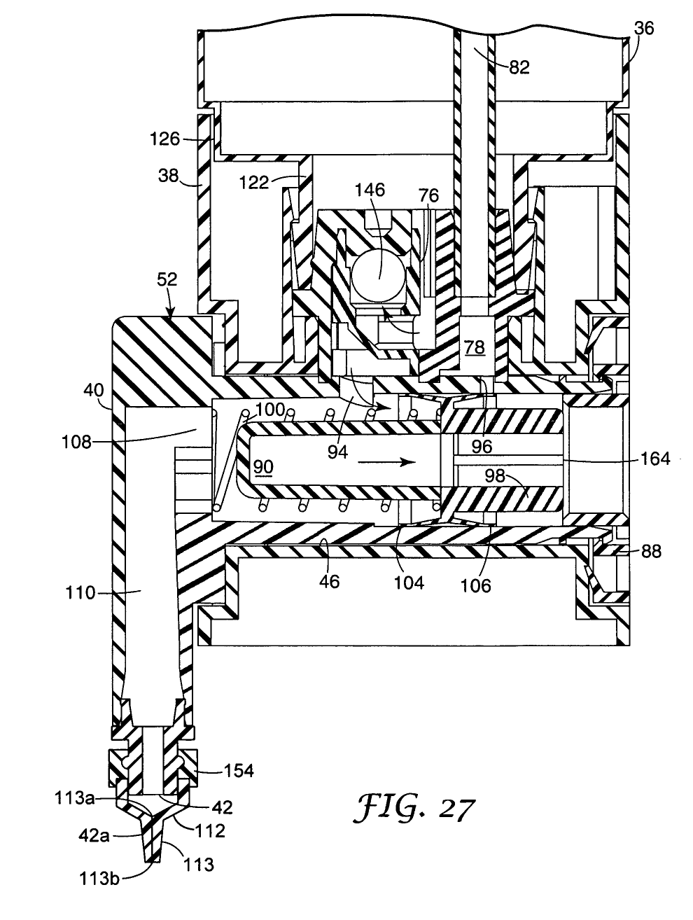

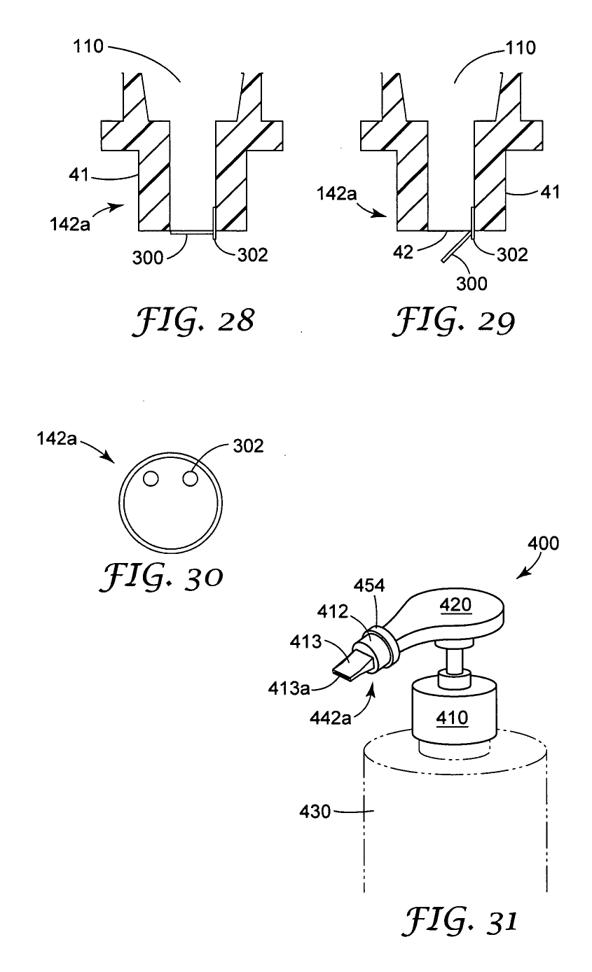

In some embodiments, the dispenser valve may be provided in the form of an elastomeric or a non-elastomeric “reed” valve 142a, shown in FIGS. 28-30. The reed valve 142a is secured over the flow outlet 42 and is capable of providing a closed condition (FIG. 28) and an opened condition (FIG. 29). The reed valve 142a includes a closure member 300 affixed to the outlet 42 in a hinged manner to permit the closure element 300 (a “reed”) to assume the opened condition at the cracking pressure for the valve to thereby dispense dispensable product. In the absence of any external force (e.g., a positive pressure differential across the valve), the closure element 300 is constructed to remain in the closed condition, as depicted in FIG. 28. In the closed condition, the closure element 300 of valve 142a prevents the escape of dispensable product and serves to retain dispensable product within the dispenser channel 110, preventing exposure of dispensable product to the drying conditions of the external air, and preventing the evaporation of solvent from the dispensable product to avoid the formation of dried residue around the outlet 42. Closure element 300 is affixed to the outlet 42 in a hinged manner to permit the closure element 300 (a “reed”) to assume an opened position at the cracking pressure. In the depicted embodiment, the element 300 is a film affixed to the outlet 42 on a pair of welded pegs 302. The closure element 300 may be secured to the pegs 302 by any suitable means such as by adhesive bonding, heat bonding, ultrasonic welding, and like. The pegs 302 are likewise secured to the inner wall of the valve channel or to the rim surrounding the outlet 42. Other means for the secural of a reed valve to the flow outlet 42 will be apparent to those skilled in the art.

Element 300 may be constructed from any of a variety of materials having a relatively high modulus of elasticity. Such materials include, for example, polyester (polyethylene terephthalate or PET), polyamides such as Nylon, polycarbonate, polyacrylate, and the like. In some embodiments, PET film having a thickness ranging from about 1 mil (0.0254 mm) to 10 mils (0.254 mm) is suitable and may be adhered to the pegs 302 by heat welding or adhesive bonding, for example. In some embodiments, pegs 302 can be mated with holes (not shown) provided in the element 300. Element 300 may also be an elastomeric member comprising materials such as those described herein for the duckbill valve. The element 300 can be a traditional film or it can comprise additional structural features such as reinforcing ribs to enhance the stiffness of the element 300, for example. Other features and/or treatments may be made to element 300 as will be appreciated by those skilled in the art.

In operation, the set up of the dispenser 30 may begin by attaching the bracket/actuator assembly 34 in a convenient location, such as on the wall by a sink or on a wheel mounted vertical pole (not shown). The foot actuated pneumatic bladder pump 220 is coupled to the bracket/actuator assembly 34 with the air hose 221 through port 214. The container assembly 32 may be attached to the bracket/actuator assembly 34 in the manner shown in FIG. 3, except that typically the valve assembly will be in the sealed position (as opposed to the dispense position shown in FIG. 3) during attachment of the container assembly 32 to the bracket/actuator assembly 34. The rear wall 39 of the container assembly 32 is placed opposite the front housing 192 of the bracket/actuator assembly 34 and the container assembly is moved in a substantially vertically downward direction 10 until the flanges 200 and 202 engage the channels 138 and 140. The flanges 200 and 202 and channels 138 and 140 are situated to automatically guide the driven surfaces 164 of the piston 98 to a position opposite the actuator 196. Engagement between the stop surfaces S and the shoulder surfaces 143 and 145 limits the insertion of the container assembly 32 into the bracket/actuator assembly 34 at the point where the piston 98 is properly oriented relative to the actuator 196.

After container assembly 32 is attached to the bracket assembly, the valve assembly can be moved from the sealed position (FIG. 2) to the dispense position (FIG. 1). Preferably, in the dispense position, the flow outlet 42 opens substantially vertically downward.

To dispense the dispensable product from the dispenser 30, a user steps on the foot actuated pneumatic bladder 220 which causes the actuator 196 to move from the retracted (FIG. 24 solid lines) position to the extended position (FIG. 24 dashed lines). Movement of the actuator from the retracted to the extended position causes the distal end of the actuator 196 to engage the driven surfaces 164 of the piston 98 and drives the piston from the return position to the actuated position. FIGS. 25 through 27 illustrate the piston 98 moving from the return position to an actuated position and back to the return position. The actuator 198 is omitted from these views to emphasize other details.

In FIG. 25, the piston 98 is biased to the return position by spring 100. The vent tube 82 and hole 96 are sealed from atmospheric air by piston seal surface 106. After the pump is primed, the pump chamber 90 is full of a precise, metered amount of dispensable product to be dispensed, regardless of the amount of dispensable product in the container. The pump chamber 90 is sealed by the piston seal surfaces 104 and 106 and the dispenser valve 42a with its valve outlet 113 in the relaxed position. Because the ball 146 of the ball valve is in a down, closed position, dispensable product from the pump chamber 90 cannot travel from the pump chamber 90 back into the container via first passageway 76. As the piston 98 moves, pressure within the pump chamber 90 increases and causes the flexible dispenser valve outlet 113 to be displaced from its relaxed position in FIG. 25 to an opened position for dispensing. Once the pressure within the pump chamber 90 dissipates sufficiently, the resilience of the dispenser valve 42a causes the valve outlet 113 to again relax and assume a sealing position. In this position, the piston seal 106 no longer seals vent hole 96 and vent tube 82 from ambient, and air is allowed to flow from ambient, through vent tube 82 and into the container. The arrows in FIG. 26 show the ingress of air into the container. FIG. 27 illustrates the piston 98 as it is being spring biased from the actuated position back to the return position. The arrows in FIG. 27 illustrate the flow of dispensable product from the container and into the pump chamber 90. The direction of the piston 98 is also illustrated in FIG. 27 with an arrow. Piston seal 106 has already sealed vent hole 96 and vent tube 82. Once the spring 100 moves the piston to the return position, the elements of the container assembly 32 are back to their position shown in FIG. 25 and the dispenser 30 is ready to be actuated again until dispensable product within the container is depleted.

When the dispensable product within the container is depleted, the entire container assembly 32 may be disposed of to reduce the chance of contaminant build up within the dispenser 30. A refill container assembly may be attached to bracket/actuator assembly 34 and the process repeated. However, in some embodiments, dispensable product with the container may be simply be replenished or a new, full container 36 may be supplied for the container assembly 32 and the other elements of the container assembly (e.g. the pump and valve assembly) may be reused.

In another embodiment, a dispenser valve according to the invention may be provided in the form of the reed valve, described elsewhere herein. Such a reed valve may be associated with the flow outlet of the hand actuated piston pump in the same manner as described above in connection with the reed valve 142a shown in FIGS. 28-30 associated with the flow outlet 42.

In another embodiment, as shown in FIG. 31, a dispenser valve 442a may be associated with a conventional hand actuated piston pump dispenser 400, such as those used to dispense hand soaps, lotions or sanitizing creams or foams. The dispenser 400 includes a connection in the form of a screw cap 410 associated with a container assembly in the form of container 430 (in phantom) for holding a dispensable product. As shown, the dispenser comprises a duckbill dispensing valve 442a, the structure of which is as previously described, having a valve body 412 and a closure element 413 which dispenses dispensable product from the valve outlet 413a. A retaining collar 454 is employed to retain the dispenser valve 442a in a proper position to receive dispensable product from a flow outlet (not shown) associated with an internal pump mechanism that is actuated by depressing the hand actuator 420. The hand actuator 420 is actuated by depressing it to prime and activate the pump mechanism by drawing dispensable product from the container 430 to an inlet of a dispensing channel, through the dispensing channel and into valve body 412.

As discussed elsewhere herein, the dispenser valve 442a can be non-preloaded and will remain in a closed (and sealed condition) in the absence of a cracking pressure across the valve 442a. When the pressure across the dispenser valve 442a exceeds the cracking pressure, the closure element 413 will assume an opened condition and allow a measured or predetermined amount of dispensable product to pass therethrough. After dispensing, the pressure across the valve 442a will again drop below the cracking pressure and the closure element 413 of the dispenser valve 442a will again assume a closed condition. In the closed condition, leakage of dispensable product is prevented. Moreover, the closure element is typically the last structure on the dispenser that the dispensable product must clear when exiting the dispenser valve 442a. As a result, the accumulation of dispensable product on structures outside of the valve 442a is prevented. In the absence of such an accumulation, the formation of residue and consequent clogging is avoided so that normal operation of the dispenser does not result in dispensable product (and residue) being forcefully ejected from the valve outlet 413a in a directionally random manner.

In embodiments of the invention, the cracking pressure for the valve 442a is less than about 20 mbar. In some embodiments, the cracking pressure is less than about 12 mbar, and in some embodiments the cracking pressure can be less than about 3 mbar. At all times, the dispenser valve 442a is a one-way valve, allowing flow from the dispenser but preventing flow back into the dispenser.

In some embodiments, not shown here, the dispenser valve 442a is configured to direct dispensed product downward, i.e., at an angle from about 20 degrees to about 90 degrees down from a horizontal plane running through the uppermost surface of hand actuator 420. In other words, when the container 430 is resting on a horizontal surface such as a table, countertop or the like, the valve outlet 413a is pointed or oriented downward at an angle that tends to direct the flow of dispensable product from the nozzle valve outlet 413a toward the horizontal surface. In this manner, the product is more readily dispensed into the hand of the user. In some embodiments, the dispensed composition is directed out of the valve outlet at an angle ranging from about 45 degrees to about 90 degrees down from a horizontal plane running through the uppermost surface of hand actuator 420.

Although the embodiments of the invention have described the foregoing dispenser in terms of dispensing dispensable product from a non-pressurized container, it will be appreciated that some embodiments of the invention may utilize a pressurized container that is capable of dispensing an aerosol product or the like. Although the type of dispensable product has been described primarily as a sanitizer or disinfecting formulation, it will be appreciated that the invention is useful for dispensing any of a variety of dispensable products. While the prevention of dispenser clogging is a goal of the invention, protection of dispensable product integrity may also be achieved. For example, dispensable products dispensed through the dispenser valve of the invention can include liquids, foams or gels that may dry to from waxes, solids or semisolids having a high viscosity as well as dispensable products that must be protected from exposure to oxygen to avoid oxidation reactions, for example.

### EXAMPLES

Additional features of the embodiments of the invention are further described in the following non-limiting examples. AVAGARD™ products referred to herein were obtained from 3M Company of St. Paul, Minn.

### Comparative Example 1

An AVAGARD™ wedge shaped dispenser 9200, was used with Wall Bracket/Foot Pump 9201C to dispense AVAGARD™ CHG lotion. After the pump was adequately primed, a first set of 10 pumps (shots) of AVAGARD™ CHG lotion were sequentially dispensed and weighed. A second set of 11 pumps (shots) was also dispensed. An average and standard deviation was calculated for each set of pumps. The average amount dispensed for the first set of 10 pumps was 1.89 grams with a standard deviation of 0.006 grams. The average amount dispensed for the second set of 11 pumps was 1.88 grams with a standard deviation of 0.024 grams.

### Example 1

The ball and spring valve was removed from an AVAGARD™ wedge shaped dispenser 9200, equipped with Wall Bracket/Foot Pump 9201C to dispense AVAGARD™ CHG lotion. A duckbill valve made of EPDM material, available as product VA 3469, part number VL297-105, from Vernay Laboratories of Yellow Springs, Ohio, was affixed to the dispenser. Prior to bonding the duckbill valve to the AVAGARD# dispenser, a plastic retainer ring was reinstalled and glued in place. The duckbill valve was bonded to the outlet of the dispenser using a two part acrylic adhesive that was cured overnight. The adhesive was obtained from 3M Company under the designation SCOTCH-WELD Structural Plastic Adhesive DP-8010.

The pump primed in less than four (4) depressions of the foot bulb. This indicated that the one-way duck bill valve sealed well and did allow air to move into the lotion pump chamber. After the pump was adequately primed, a set of 10 pumps (shots) of AVAGARD™ CHG lotion were sequentially dispensed and weighed. An average and a standard deviation were calculated for the set of 10 pumps. The average amount dispensed was 1.92 grams with a standard deviation of 0.011 grams.

### Example 2

The ball and spring check valve was removed from the 9200 dispenser which was equipped with Wall Bracket/Foot Pump 9201C to dispense the AVAGARD™ CHG lotion. A duckbill check valve made of Nitrile material, available as product VA 3640, part number VL 1396-101, from Vernay Laboratories of Yellow Springs, Ohio was affixed to the dispenser. Prior to bonding the duckbill valve to the AVAGARD™ dispenser, a plastic retainer ring was reinstalled and glued in place. The duckbill valve was then bonded to the exit nozzle of the dispenser using a two part acrylic adhesive and allowed to cure overnight. The adhesive was obtained from 3M Company under the designation SCOTCH-WELD Structural Plastic Adhesive DP-8010.

The pump primed in less than four (4) depressions of the foot bulb. This indicated that the one-way duck bill valve sealed well and did allow air to move into the lotion pump chamber. After the pump was adequately primed, a set of 10 pumps (shots) of AVAGARD™ CHG lotion were sequentially dispensed and weighed. An average and a standard deviation were calculated for the set of 10 pumps. The average amount dispensed was 1.92 grams with a standard deviation of 0.013 grams.

### Examples 3-7

A variety of duckbill valves from Vernay Laboratories of Yellow Springs, Ohio were fixed to a 1 ml output lotion pump (piston pump) obtained from Sequist Perfect Dispensing of Cary, Ill. and identified by the designation “Pump Falcon PP” Model No. 185578. The duckbill valves were affixed to the outlet of the pump using one of several adhesives. The pump was mounted in a 16 ounce lotion container containing AVAGARD™ D lotion (having 7.1% solids). The valves and adhesives are summarized in the following table.

| Example | Valve (Vernay Part No.) | Valve Elastomer | Adhesive |
|---|---|---|---|
| 3 | VA3469 (VL297-105) | EPDM | 3M 8010¹ |
| 4 | VA3640 (VL1396-101) | Nitrile | 3M 8010 |
| 5 | VA3640 (VL1396-101) | Nitrile | 3M CA40H² |
| 6 | VA3640 (VL2461-102) | Silicone | Dow Corning |
| | | | RTV 732³ |
| 7 | VA3640 (VL2461-102) | Silicone | 3M RTV⁴ |

¹3M 8010 is available as “Scotch-Weld” acrylic structural plastic adhesive DP8010, 2 part; obtained from 3M Company, St. Paul, MN.
²3M CA40H is available as “Scotch-Weld” Instant Adhesive CA40H (cyanoacrylate); obtained from 3M Company, St. Paul, MN.
³Dow Corning RTV 732 adhesive is obtained from Dow Corning, Midland, MI
⁴3M RTV is available as “3M Super Silicone Sealant” (Black) PN 08662; obtained from 3M Company, St. Paul, MN.

To install the duckbill valves, the outlets on the dispensers were roughed up with 280 grit 3M “Wet or Dry” sand paper prior to application of an adhesive. The adhesive was applied to the outlet of the dispenser and a duckbill valve was slid over the outlet and the adhesive was allowed to dry. AVAGARD™ D lotion was dispensed through the duckbill valves on a periodic basis by allowing the valve and dispenser to sit unused overnight between each dispense to permit residual lotion within the valve an opportunity to dry if that was to occur. This was repeated for several days. A “Pump Falcon PP” pump, model no. 185578 with no duckbill valve was used as a control pump by dispensing AVAGARD™ D lotion in a manner similar to that described for Examples 3-7. The control pump consistently developed a residue consisting of a mass of dried lotion within the nozzle outlet after being allowed to dry only a few hours. During the dispense of lotion, the solid residue tended to come out of the outlet as a discrete plug, and the dispensed lotion tended to jet out at odd angles from the outlet of the control pump in the presence of residue. However, all pumps equipped with duckbill nozzles (Examples 3-7) continued to pump without clogging, even after sitting overnight.

The present invention has been described with reference to embodiments thereof. It will be apparent by those skilled in the art that changes, modifications or additions can be made to the described embodiments without departing from the scope of the present invention.

What is claimed:

1. A dispenser comprising:
a connection for connecting the dispenser to a container for holding dispensable product therein;
a dispenser valve comprising a valve outlet having a closure element configured to assume an opened condition when the pressure differential across the dispenser valve reaches a cracking pressure and a closed condition when the pressure differential across the dispenser valve is less than the cracking pressure, the dispenser valve configured to permit flow therethrough in only one direction when the closure element is in the opened condition; and
a pump mechanism configured to pump dispensable product from the connection to the dispenser valve and to generate the cracking pressure needed to configure the closure element in the opened condition.

2. The dispenser of claim 1 wherein the dispenser valve is non-preloaded.

3. The dispenser of claim 1 wherein the valve outlet is sealed when the closure element is in the closed condition to prevent flow of dispensable product through the valve outlet and to prevent the backflow of air through the valve outlet into dispenser valve.

4. The dispenser of claim 1 wherein the dispenser valve is a duckbill valve.

5. The dispenser of claim 4 wherein the dispenser valve comprises one or more elastomers.

6. The dispenser of claim 5 wherein the elastomers comprise material selected from the group consisting of thermoplastic polymer, thermosetting polymer and combinations thereof.

7. The dispenser of claim 5 wherein the elastomers comprise material selected from the group consisting of ethylene propylene diene monomer; silicone rubber; nitrile rubber; polyurethane, fluorinated elastomers, and combinations of two or more of the foregoing.

8. The dispenser of claim 7 wherein the synthetic rubber comprises material selected from polybutadiene rubber; polyisoprene rubber; styrene-butadiene rubber; block copolymers and combinations of two or more of the foregoing.

9. The dispenser of claim 1 wherein the dispenser is configured to dispense a predetermined amount of dispensable product, the predetermined amount of dispensable product being reproducible within about 10% to about 15% on a weight basis.

10. The dispenser of claim 1 wherein the cracking pressure across the dispenser valve is less than about 20 mbar.

11. The dispenser of claim 1 wherein the cracking pressure across the dispenser valve is less than about 12 mbar.

12. The dispenser of claim 1 wherein the cracking pressure across the dispenser valve is less than about 3 mbar.

13. The dispenser of claim 1 wherein the dispenser valve is a reed valve comprising a closure element affixed to the outlet, the closure element being capable of assuming an opened condition and a closed condition.

14. The dispenser of claim 13 wherein the closure element is a film having a thickness from about 1 mil (0.0254 mm) to about 10 mils (0.254 mm).

15. The dispenser of claim 14 wherein the film comprises a material selected from the group consisting of polyester, polyamide, polycarbonate, polyacrylate, and combinations of two or more of the foregoing.

16. The dispenser of claim 15 wherein the polyester is polyethylene terephthalate.

17. The dispenser of claim 14 wherein the closure element further comprises reinforcing ribs.

18. The dispenser of claim 1, further comprising:
a container assembly connected to the connection, the container assembly comprising a container for holding a volume of dispensable product therein;
the pump mechanism being associated with the container assembly for pumping a predetermined amount of dispensable product from the container, the predetermined amount being reproducible within about 10% to about 15% on a weight basis; and
a dispensing channel having an inlet proximal to the pump mechanism, the dispensing channel positioned to direct dispensable product from the inlet to the dispenser valve.

19. The dispenser of claim 18 further comprising a bracket/actuator assembly comprising a bracket for retaining the container assembly and an actuator for actuating the pump mechanism for pumping dispensable product from the container.

20. The dispenser of claim 19 further comprising and a foot pump operatively associated with the actuator to move the actuator from a retracted position in which the pumping mechanism is not engaged, to an extended position in which the pumping mechanism is actuated to pump dispensable product from the container to the dispensing channel.

21. The dispenser of claim 18 wherein the container assembly is disposable.

22. The dispenser of claim 18 wherein the bracket actuator assembly is mountable on a vertical surface.

23. A system comprising:
the dispenser of claim 1;
a container associated with the connection; and
dispensable product contained within the container.

24. The system of claim 23 wherein the dispensable product is an antiseptic lotion comprising one or more volatile solvents and more than about 2% solids, the lotion being suitable for use on mammalian skin.

25. A system, comprising:
the dispenser of claim 18; and
dispensable product contained within the container.

26. The system of claim 25 wherein the dispensable product is an antiseptic lotion comprising more than about 2% solids in a volatile solvent, the lotion being suitable for use on mammalian skin.

27. A dispenser comprising:
a connection for connecting the dispenser to a container for holding dispensable product therein;
a dispenser valve selected from the group consisting of a reed valve and a duckbill valve, the dispenser valve comprising a valve outlet having a closure element configured to assume an opened condition when the pressure differential across the dispenser valve reaches a cracking pressure and a closed condition when the pressure differential across the dispenser valve is less than the cracking pressure; and
a pump mechanism configured to pump dispensable product from the connection to the dispenser valve and to generate the cracking pressure needed to configure the closure element in the opened condition.

28. The dispenser of claim 27 wherein the dispenser valve is non-preloaded.

29. The dispenser of claim 27 wherein the valve outlet is sealed when the closure element is in the closed condition to prevent flow of dispensable product through the valve outlet and to prevent the backflow of air through the valve outlet into dispenser valve.

30. The dispenser of claim 27 wherein the dispenser valve is a duckbill valve comprising one or more elastomers selected from the group consisting of thermoplastic polymer, thermosetting polymer, ethylene propylene diene monomer; silicone rubber; nitrile rubber; polyurethane, fluorinated elastomers, and combinations of two or more of the foregoing.

31. The dispenser of claim 30 wherein the synthetic rubber comprises material selected from polybutadiene rubber; polyisoprene rubber; styrene-butadiene rubber; block copolymers and combinations of two or more of the foregoing.

32. The dispenser of claim 27 wherein the dispenser is configured to dispense a predetermined amount of dispensable product, the predetermined amount of dispensable product being reproducible within about 10% to about 15% on a weight basis.

33. The dispenser of claim 27 wherein the cracking pressure across the dispenser valve is less than about 20 mbar.

34. The dispenser of claim 27 wherein the dispenser valve is a reed valve.

35. The dispenser of claim 34 wherein the closure element is a film having a thickness from about 1 mil (0.0254 mm) to about 10 mils (0.254 mm), the film comprising a material selected from the group consisting of polyester, polyamide, polycarbonate, polyacrylate, and combinations of two or more of the foregoing.

36. The dispenser of claim 35 wherein the polyester is polyethylene terephthalate.

37. The dispenser of claim 35 wherein the closure element further comprises reinforcing ribs.

38. The dispenser of claim 27, further comprising:
a container assembly connected to the connection, the container assembly comprising a container for holding a volume of dispensable product therein;
the pump mechanism being associated with the container assembly for pumping a predetermined amount of dispensable product from the container, the predetermined amount of dispensable product being reproducible within about 10% to about 15% on a weight basis; and
a dispensing channel having an inlet proximal to the pump mechanism, the dispensing channel positioned to direct dispensable product from the inlet to the dispenser valve.

39. The dispenser of claim 38 further comprising a bracket/actuator assembly comprising a bracket for retaining the container assembly and an actuator for actuating the pump mechanism for pumping dispensable product from the container.

40. The dispenser of claim 38 further comprising a foot pump operatively associated with the actuator to move the actuator from a retracted position in which the pumping mechanism is not engaged, to an extended position in which the pumping mechanism is actuated to pump dispensable product from the container to the dispensing channel.

41. The dispenser of claim 38 wherein the container assembly is disposable.

42. The dispenser of claim 39 wherein the bracket actuator assembly is mountable on a vertical surface.

43. A system comprising:
the dispenser of claim 27
a container associated with the connection; and
dispensable product contained within the container.

44. The system of claim 43 wherein the dispensable product is an antiseptic lotion comprising one or more volatile solvents and more than about 2% solids, the lotion being suitable for use on mammalian skin.

45. A system, comprising:
the dispenser of claim 38; and
dispensable product contained within the container.

46. The system of claim 45 wherein the dispensable product is an antiseptic lotion comprising more than about 2% solids in a volatile solvent, the lotion being suitable for use on mammalian skin.
